(19) United States
(12) Patent Application Publication
(10) Pub. No.: US 2025/0089722 A1
(43) Pub. Date: Mar. 20, 2025

(54) PSEUDOMONAS STRAINS AND THEIR METABOLITES TO CONTROL PLANT DISEASES

(71) Applicants: T3 BIOSCIENCE, INC., MEQUON, WI (US); UWM RESEARCH FOUNDATION, INC., MILWAUKEE, WI (US)

(72) Inventors: Ching-Hong Yang, Mequon, WI (US); Jian Huang, Milwaukee, WI (US)

(21) Appl. No.: 18/963,593

(22) Filed: Nov. 28, 2024

Related U.S. Application Data
(63) Continuation-in-part of application No. 18/103,082, filed on Jan. 30, 2023, now Pat. No. 12,167,733.

(51) Int. Cl. A01N 63/27; A01N 43/40; A01P 3/00

(52) U.S. Cl. CPC A01N 63/27; A01N 43/40; A01P 3/00

(57) ABSTRACT

The present disclosure concerns methods of using novel bacterial strains of 0617-T307, 0917-T305, 0917-T306, 0917-T307, 0118-T319, 0318-T327, and 0418-T328, and the cell broth and novel metabolites produced from the bacterial strains, to inhibit the growth of a variety of pathogenic microorganism for a variety of crops. This method is effective against a broad range of fungal pathogens, including Pythium aphanidermatum, Podosphaera xanthii, Plasmopara viticola, Erysiphe cichoracearum, Pseudoperonospora cubensis, Clarireedia jacksonii, Microdochium nivale, and Podosphaera leucotricha. The methods include the application of Formula (I) in various formulations to inhibit pathogenic microorganisms in crops such as cucurbits, legumes, leafy greens, root vegetables, oilseed crops, ornamental plants, fruit crops, and turfgrass. The methods include the use of an agricultural composition including a novel, potent antimicrobial metabolite produced from the bacterial strains corresponding to the compound having Formula (I):

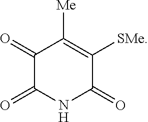 [SMILES: CSC1=C(C)C(=O)C(=O)NC1=O]

### CROSS-REFERENCE TO RELATED APPLICATIONS

This application is a continuation-in-part of U.S. patent application Ser. No. 18/103,082, filed Jan. 30, 2023, entitled “PSEUDOMONAS STRAINS AND THEIR METABOLITES TO CONTROL PLANT DISEASES, which is a continuation of U.S. patent application Ser. No. 17/063,540, filed Oct. 5, 2020, now U.S. Patent Publication U.S. Pat. No. 11,582,973 B2, which issued Feb. 21, 2023, entitled “PSEUDOMONAS STRAINS AND THEIR METABOLITES TO CONTROL PLANT DISEASES,” the contents each of which are incorporated by reference herein in their entireties.

### FIELD OF THE INVENTION

This invention is in the field of biopesticides. In particular, the invention pertains to seven novel strains of Pseudomonas spp, 0617-T307, 0917-T305, 0917-T306, 0917-T307,0118-T319, 0318-T327, and 0418-T328, the cell broth and novel metabolites produced from the bacterial strain that can inhibit the growth of a variety of microbial species. The Pseudomonas strains of 0617-T307, 0917-T305, 0917-T306, 0917-T307, 0118-T319, 0318-T327, and 0418-T328 have been deposited in the American Type Culture Collection (ATCC) and have ATCC accession number PTA-126796, PTA-126797, PTA-126798, PTA-126799,PTA-126800, PTA-126801, and PTA-126802, respectively.

In particular, the present invention relates to methods for inhibiting fungal pathogens using Formula (I) (RejuAgro A), a novel antimicrobial compound produced by the foregoing Pseudomonas strains. Formula (I) (RejuAgro A) is designed to target a range of economically significant fungal pathogens that affect various crops, including cucurbits, okra, grapes, turfgrass, and others. These pathogens include Pythium aphanidermatum, Podosphaera xanthii, Plasmopara viticola, Erysiphe cichoracearum, Pseudoperonospora cubensis, Clarireedia jacksonii, Microdochium nivale, and Podosphaera leucotricha. The invention provides methods of applying Formula (I) (RejuAgro A) in agricultural formulations for effective disease control, offering a solution to fungal pathogens resistant to conventional fungicides.

New biopesticides derived from novel microbial strains, cell broths, and novel metabolites produced from such strains are needed to inhibit the growth of various crop disease-causing pathogens, including the aforementioned fungal pathogens.

### BACKGROUND OF THE INVENTION

Fungal pathogens pose a serious threat to global agriculture, causing significant yield losses and reductions in crop quality. The increasing resistance of many fungal species to conventional fungicides underscores the urgent need for novel and sustainable control methods. Pathogens such as Pythium aphanidermatum in seedlings, Podosphaera xanthii in cucurbit crops, Plasmopara viticola in grapevines, Erysiphe cichoracearum in crops like okra and lettuce, Pseudoperonospora cubensis in cucumbers and other cucurbits, Clarireedia jacksonii in turfgrass, Microdochium nivale in turfgrass with snow cover, and Podosphaera leucotricha in apples, remain persistent and destructive problems in crop production.

Pythium aphanidermatum causes damping-off and root rot in seedlings, particularly in hydroponic systems (Elshahawy and El-Mohamedy 2019). It attacks a wide range of plants, including cucumbers, peppers, tomatoes, and ornamentals. This pathogen spreads rapidly in moist conditions, leading to seedling death and poor crop establishment.

Podosphaera xanthii, a powdery mildew pathogen, primarily infects cucurbit crops such as zucchini, cucumbers, melons, and squash (Pérez-García, Romero et al. 2009). Powdery mildew causes white fungal growth on the leaves, reducing photosynthetic capacity and leading to premature defoliation. Warm, dry conditions exacerbate the spread of P. xanthii.

Plasmopara viticola, which causes downy mildew in grapevines, primarily affects leaves, shoots, and fruit clusters (Gouveia, Santos et al. 2024). This pathogen thrives in wet, humid conditions, leading to rapid disease progression and substantial yield losses. Resistance to commonly used fungicides is an ongoing issue, necessitating alternative treatments.

Erysiphe cichoracearum causes powdery mildew in crops such as okra, sunflower, lettuce, beans, and ornamental plants (Jiao, Cai et al. 2021). Powdery mildew reduces plant vigor and yield, particularly in warm, dry conditions.

Pseudoperonospora cubensis causes downy mildew in cucumbers and other cucurbits (Savory, Granke et al. 2011). This pathogen leads to yellowing and angular lesions on leaves, resulting in defoliation and yield reduction. The disease is particularly severe in humid environments, and fungicide resistance complicates control.

Clarireedia jacksonii is the primary pathogen responsible for dollar spot in turfgrass (Groben, Clarke et al. 2020). This disease affects a wide range of grasses used on golf courses, lawns, and athletic fields, resulting in unsightly brown patches and poor turf quality. C. jacksonii thrives in warm, humid conditions and is challenging to control due to its persistence and fungicide resistance.

Microdochium nivale causes pink snow mold in turfgrass, particularly in regions with prolonged snow cover (Gorshkov, Osipova et al. 2020). The disease leads to circular patches of discolored, matted grass, which can result in poor recovery in the spring.

Podosphaera leucotricha is the fungal pathogen responsible for causing powdery mildew on apple trees (Strickland, Spychalla et al. 2023). This disease primarily affects the leaves, buds, and fruit, leading to reduced photosynthesis, stunted growth, and diminished fruit quality. Infected trees display a characteristic white, powdery fungal growth on leaves and shoots, and, if left unmanaged, the disease can cause significant yield losses. P. leucotricha thrives in warm, dry climates and can be particularly challenging to control due to its ability to overwinter in buds and its rapid spread during favorable conditions. Effective management is crucial for maintaining healthy apple production.

### BRIEF SUMMARY OF THE INVENTION

In a first aspect, a method of controlling a disease in a crop caused by a pathogenic microorganism is provided. The method includes several steps. One step is producing an agricultural composition comprising a Pseudomonas bacterial metabolite as Formula (I)

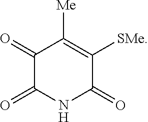 [SMILES: CSC1=C(C)C(=O)C(=O)NC1=O]

A second step is applying the agricultural composition to the crop to inhibit the growth of the pathogenic microorganism.

In a second aspect, a method of controlling a disease in a crop caused by a pathogenic microorganism is provided. The method includes the step of applying an agricultural composition comprising between 1.0×10⁵ and 1.0×10⁹ cfu per mL of a Pseudomonas bacterial strain to the crop to inhibit the growth of the pathogenic microorganism.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates exemplary plot of the maximum likelihood phylogeny of representative Pseudomonas lineages based on a concatenated alignment of 16S rDNA, gyrB, rpoB and rpoD. The bootstrap support values were labeled below the four internal branches that received <100% support. Those not labeled represent 100% support.

FIG. 2 illustrates an example of assay-guided isolation of ethyl acetate extract of strain 0617-T307.

FIG. 3A depicts exemplary culture plots showing the amount of RejuAgro A in a shaking flask fermentation in which the distribution of RejuAgro A in the cell broth, supernatant and cells.

FIG. 3B depicts an exemplary plot of the production of RejuAgro A from cell fermentation over time.

FIG. 4 depicts exemplary agar plates showing V. inaequalis can grow on PDA plates with PDA alone without additives (plate A); with 0.25% 0.01M PBS (plate B) or 0.8% DMSO (plate C) or 1.6% DMSO (plate D) on day 14.

FIG. 5 depicts exemplary agar plates showing V. inaequalis cannot grow on PDA plates containing the selected four biocontrol bacteria (plate A: 0617-T307; plate B: 0118-T319; plate C: 0318-T327; plate D: 0418-T328) on day 14.

FIG. 6 depicts exemplary agar plates showing V. inaequalis cannot grow on PDA plates containing 40-80 μg/mL RejuAgro A on day 14 (plate A: 10 μg/mL in PDA plate; plate B: 20 μg/mL in PDA plate; plate C: 40 μg/mL in PDA plate; plate D: 80 μg/mL in PDA plate).

FIG. 7 depicts exemplary agar plates showing V. inaequalis can grow on PDA plates containing 10-80 μg/mL RejuAgro B on day 14 (plate A: 10 μg/mL in PDA plate; plate B: 20 μg/mL in PDA plate; plate C: 40 μg/mL in PDA plate; plate D: 80 μg/mL in PDA plate).

FIG. 8 depicts exemplary agar plates showing V. inaequalis can grow on PDA plates containing 200-1000 μg/mL copper sulfate on day 14 (plate A: PDA plate with 500 ug/mL CuSO₄; plate B: PDA plate with 1000 μg/mL CuSO₄).

FIG. 9 depicts an exemplary amount-peak area curve of RejuAgro A analyzed by HPLC at the wavelength of 407 nm.

FIG. 10 depicts exemplary data on RejuAgro A production from different bacterial strains.

FIG. 11 depicts an exemplary antifungal assay against Botrytis cinerea CA17,wherein panel A depicts (1) 40 μL Nystatin at 50 mg/mL, (2) 40 μL DMSO; panel B depicts (1) M9 medium for 24 h, (2) M8 medium for 24 h, (3) M7 medium for 24 h, (4) M6 medium for 24 h; panel C depicts (1) M9 medium for 12 h, (2) M8 medium for 12 h, (3) M7 medium for 12 h, and (4) M6 medium for 12 h.

FIG. 12 depicts an exemplary agar plates of M. fijiensis showing inhibitory growth in the presence of RejuAgro A at 600 μg/mL (panel A) but growth in the presence of RejuAgro A at 60 μg/mL (panel B) or without RejuAgro A (panel C).

FIG. 13 depicts bioactivity assays on Pythium aphanidermatum treated with varying concentrations of Formula (I) (RejuAgro A) at 62.5, 125, and 250 μg/mL, respectively. The assay demonstrates the inhibitory effect of Formula (I) on fungal growth across these concentrations.

FIG. 14 depicts bioactivity assays on zucchini leaves infected with powdery mildew (Podosphaera xanthii) treated with different concentrations of Formula (I) (RejuAgro A), abbreviated as RAA. Panels A and B: RAA at 20 μg/mL (RAA 20) and 40 μg/mL (RAA 40) effectively reduced the white powdery mycelia and symptoms of P. xanthii on zucchini leaves compared to the untreated control (CK). The brown areas in the images represent damaged plant tissue caused by P. xanthii, which became visible after the white mycelium on the surface was eliminated by RAA treatment; Panel C: The mycelial structures of P. xanthii were notably deformed in both RAA 20 and RAA 40 treatments compared to the untreated control (CK).

in

FIG. 15 depicts bioactivity assays on grapevine leaves infected with downy mildew (Plasmopara viticola), treated with different concentrations of Formula (I) (RejuAgro A), abbreviated as RAA. RAA at 20 μg/mL (RAA 20) and 40 μg/mL (RAA 40) effectively reduced the P. viticola mycelia and the white powdery symptoms associated with pathogen colonization on the grapevine leaves. The brown areas in the images represent damaged plant tissue caused by P. viticola, which became visible after the white mycelium on the surface was eliminated by RAA treatment. CK, untreated control.

FIG. 16 depicts bioactivity assays on okra leaves infected with powdery mildew (Erysiphe cichoracearum), treated with different concentrations of Formula (I) (RejuAgro A), abbreviated as RAA. RAA at 20 μg/mL (RAA 20) and 40 μg/mL (RAA 40) effectively reduced the mycelial growth of E. cichoracearum and the associated white powdery symptoms on the okra leaves. The brown areas in the images represent damaged plant tissue caused by E. cichoracearum, which became visible after the white mycelium on the surface was eliminated by RAA treatment. CK, untreated control.

### DETAILED DESCRIPTION

The present invention relates to a novel metabolite produced by seven Pseudomonas strains listed in this patent, such as 0617-T307, that exhibits antimicrobial activity against pathogenic microorganisms, in particular fungi. From the 16S rRNA and other housekeeping gene sequences, the strain was identified as Pseudomonas soli 0617-T307 in the Pseudomonas putida group. The cell broth of the 7 bacterial strains, such as 0617-T307, contains a novel, potent 6-membered heterocycle natural product which is designated as RejuAgro A, along with a dimer RejuAgro B, as depicted below:

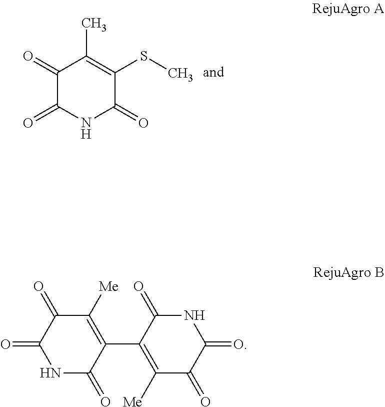 [SMILES: CSC1=C(C)C(=O)C(=O)NC1=O ; CC1=C(C2=C(C)C(=O)C(=O)NC2=O)C(=O)NC(=O)C1=O]

These compounds, their method of production, and applications for inhibiting plant microbial pathogens are disclosed in greater detail herein.

### Definitions

When introducing elements of aspects of the disclosure or particular embodiments, the articles “a,” “an,” “the,” and “said” are intended to mean that there are one or more of the elements. The terms “comprising,” “including,” and “having” are intended to be inclusive and mean that there may be additional elements other than the listed elements. The term “or” means any one member of a particular list and also includes any combination of members of that list, unless otherwise specified.

As intended herein, the terms “substantially,” “approximately,” and “about” and similar terms are intended to have a broad meaning in harmony with the common and accepted usage in the art to which the subject matter of this disclosure pertains. It should be understood by those of skill in the art who review this disclosure that these terms are intended to allow a description of certain features described and claimed without restricting the scope of these features to precise numerical ranges provided. In particular, the term “about” as modifying a particular value, such as “about 20 μg/mL” or “about 300 μg/mL,” is interpreted as being within a range of 20 percent above or below that particular value. Accordingly, these terms should be interpreted as indicating that insubstantial or inconsequential modifications or alterations of the subject matter described and claimed are considered to be within the scope of the invention as recited in the appended claims.

“Biological control agents (or BCAs)” are a way of managing pests, such as pathogens, weeds and insects, safely, sustainably, and cost-effectively. These agents are introduced into the environment to target a pest species, with the aim of reducing the pest's population or abundance in the environment.

“Biologicals” are preparations of living microorganisms (bacteria and yeasts) that produce colonies on the hosts. These microorganisms are applied mainly to slow the pathogen buildup during the epiphytic phase (Tianna et al. (2018)).

“Biorational” is a term applied to microbe-based biopesticides. These biopesticides are often made by fermenting microbial strains. Most of these products have both anti-bacterial and anti-fungal activity (Tianna et al. (2018)).

“Biopesticides” is defined by The US Environmental Protection Agency (EPA) to be pesticides derived from natural materials and categorizes them as either biochemical pesticides, containing substances that control pests by nontoxic mechanisms, microbial pesticides, consisting of microorganisms that typically produce bioactive natural products (BNPs), or plant-incorporated-protectants with activity produced by plants because of added genetic materials Gwinn K. D. (2018)).

The compounds referred to as RejuAgro A, RejuAgro B and RejuAgro C correspond to chemical compounds having the formulas (I), (II) and (III), respectively, as illustrated below:

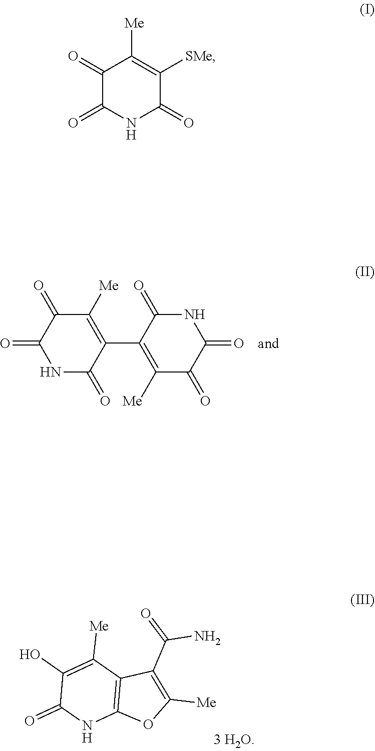 [SMILES: CSC1=C(C)C(=O)C(=O)NC1=O ; CC1=C(C2=C(C)C(=O)C(=O)NC2=O)C(=O)NC(=O)C1=O ; Cc1oc2[nH]c(=O)c(O)c(C)c2c1C(N)=O]

In a first aspect, a method of controlling a disease in a crop caused by a pathogenic microorganism is provided. The method includes several steps. One step is producing an agricultural composition comprising a Pseudomonas bacterial metabolite as Formula (I)

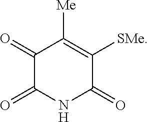 [SMILES: CSC1=C(C)C(=O)C(=O)NC1=O]

A second step is applying the agricultural composition to the crop to inhibit the growth of the pathogenic microorganism.

In a first respect, the disease in the crop caused by the pathogenic microorganism selected from the group consisting of damping-off, root rot, powdery mildew, downy mildew, dollar spot, and pink snow mold. In a second respect, the pathogenic microorganism is selected from the group consisting of Pythium aphanidermatum, Podosphaera xanthii, Plasmopara viticola, Erysiphe cichoracearum, Pseudoperonospora cubensis, Clarireedia jacksonii, Microdochium nivale, and Podosphaera leucotricha. In a third respect, the crop is selected from the group consisting of cucurbits, legumes, leafy greens, root vegetables, oilseed crops, ornamental plants, fruit crops, and turfgrass. Examples of cucurbits include but are not limited to zucchini, cucumbers, melons, and squash. Examples of legumes include but are not limited to beans and peas. Examples of leafy greens include but are not limited to lettuce and spinach. Examples of root vegetables include but are not limited to carrots and beets. Examples of oilseed crops include but are not limited to sunflower. Examples of ornamental plants include but are not limited to chrysanthemums. Examples of fruit crops include but are not limited to grapes and apples. In a fourth respect, the method further includes the step of controlling an infection in the crop by the pathogenic microorganism after a specified duration of applying the agricultural composition at an effective concentration to the crop. In a fifth respect, the effective concentration of the agricultural composition is from about 20 μg/mL to about 300 μg/mL of Formula (I). In a sixth respect, the bacterial strain used for producing the agricultural composition is selected from the group consisting of Pseudomonas soli 0617-T307 having Accession No. PTA-126796, Pseudomonas soli 0917-T305 having Accession No. PTA-126797, Pseudomonas soli 0917-T306 having Accession No. PTA-126798, Pseudomonas soli 0917-T307 having Accession No. PTA-126799, Pseudomonas mosselii 0118-T319 having Accession No. PTA-126800, Pseudomonas mosselii 0318-T327 having Accession No. PTA-126801, and Pseudomonas mosselii 0418-T328 having Accession No. PTA-126802. In a seventh respect, the agricultural composition selected from the group consisting of a solution, a suspension concentrate, a wettable powder, a water-dispersible granule, or a soluble liquid. In an eighth respect, the agricultural composition additionally includes an adjuvant, a surfactant, or a solvent to enhance the efficacy of Formula (I). In a ninth respect, the method includes the step of applying the agricultural composition to the crop that is performed by treating the crop with the agricultural composition selected from the group consisting of a foliar spray, a soil drench, or a seed coating. In a tenth respect, the agricultural composition protects the crop against disease caused by the pathogenic microorganism for at least seven days post-application of the agricultural composition.

In a second aspect, a method of controlling a disease in a crop caused by a pathogenic microorganism is provided. The method includes the step of applying an agricultural composition comprising between 1.0×10⁵ and 1.0×10⁹ cfu per mL of a Pseudomonas bacterial strain to the crop to inhibit the growth of the pathogenic microorganism.

In a first respect, the Pseudomonas bacterial strain is selected from the group consisting of Pseudomonas soli 0617-T307 having Accession No. PTA-126796, Pseudomonas soli 0917-T305 having Accession No. PTA-126797, Pseudomonas soli 0917-T306 having Accession No. PTA-126798, Pseudomonas soli 0917-T307 having Accession No. PTA-126799, Pseudomonas mosselii 0118-T319 having Accession No. PTA-126800, Pseudomonas mosselii 0318-T327 having Accession No. PTA-126801, and Pseudomonas mosselii 0418-T328 having Accession No. PTA-126802.

### Biological Deposit Information

One of the inventors, Dr. Ching-Hong Yang (residing at 10120 N. Sheridan Dr., Mequon, WI 53902, US), acting on behalf of Applicants, submitted the bacterial strains Pseudomonas soli 0617-T307, Pseudomonas soli 0917-T305, Pseudomonas soli 0917-T306, Pseudomonas soli 0917-T307, Pseudomonas mosselii 0118-T319, Pseudomonas mosselii 0318-T327, and Pseudomonas mosselii 0418-T328 to the American Type Culture Collection (ATCC®), P.O. Box 1549, Manassas, VA 20110 USA (“ATCC Patent Depository”) on Jun. 25, 2020, as evidenced by the Form PCT/RO/134, “Indications Relating to Deposited Microorganism,” under PCT Rule 13bis (filed with this application) and were accorded unofficial ATCC patent numbers PTA-126796, PTA-126797, PTA-126798, PTA-126799,PTA-126800, PTA-126801, and PTA-126802, respectively. Following viability testing, the ATCC Patent Depository accorded these deposited bacterial strains the following Accession numbers, effective Jun. 25, 2020: Pseudomonas soli 0617-T307, having Accession No. PTA-126796; Pseudomonas soli 0917-T305, having Accession No. PTA-126797; Pseudomonas soli 0917-T306, having Accession No. PTA-126798; Pseudomonas soli 0917-T307, having Accession No. PTA-126799; Pseudomonas mosselii 0118-T319, having Accession No. PTA-126800; Pseudomonas mosselii 0318-T327, having Accession No. PTA-126801; and Pseudomonas mosselii 0418-T328, having Accession No. PTA-126802. Dr. Yang grants permission to Applicants to include this biological deposit disclosure in the present application and gives his unreserved and irrevocable consent to it being made available to the public as of the filing date.

The Biological Deposit information is presented as appendices for this disclosure, which are incorporated by reference in their entirety.

### EXAMPLES

### Example 1. Identification and Characterization of Strain 0617-T307

Partial sequences from 16S rDNA, gyrB, rpoB and rpoD were analyzed. These four genes are the recommended markers for multilocus sequence analysis (MLSA) in Pseudomonas species (Peix et al. (2018)).

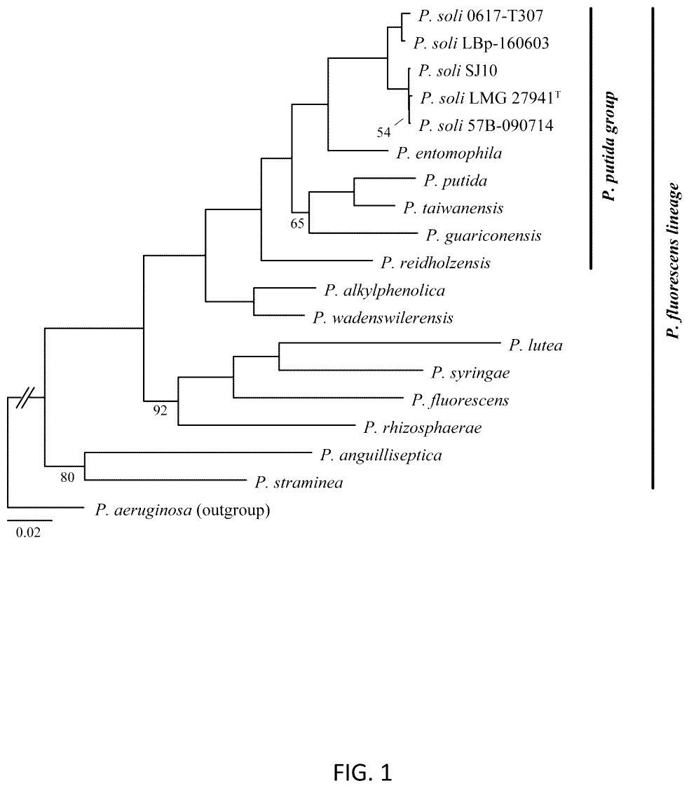

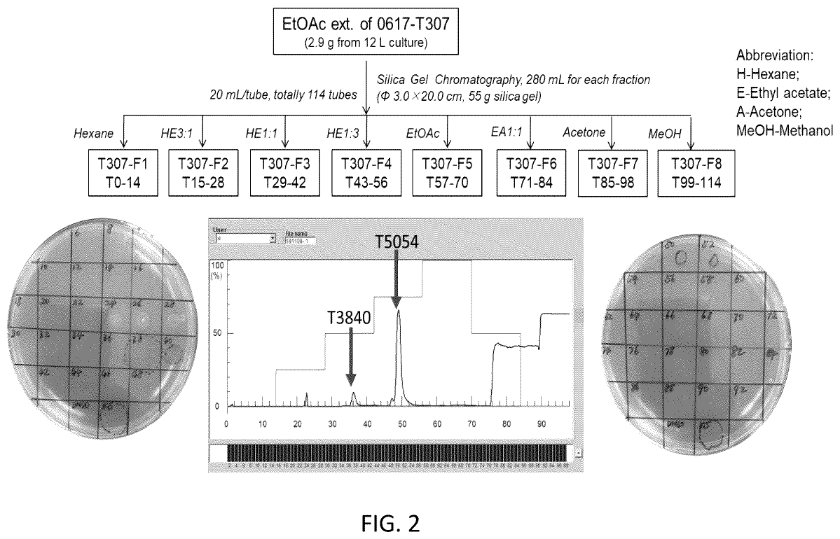

For species assignment, these four sequences were used to run BLASTN against the NCBI non-redundant nucleotide database. Based on the result, strain 0617-T307 is closely related to Pseudomonas species in the P. putida group within the P. fluorescens lineage. The “MLSA phylogeny” and “list of genomes from the type strains of Pseudomonas spp.” of (Peix et al. (2018); see FIG. 2 and Table 2 in Peix et al. (2018)) were used as the guide for taxon sampling (FIG. 1). Based on this information, the genomes were obtained from GenBank. All species in the P. putida group with high quality genome assemblies were included. Because 0617-T307 has the highest rpoD (i.e., the gene with the highest resolution power for Pseudomonas species assignation) sequence similarity with P. soli, all four available genomes of P. soli were included in the sampling (including the type strain of P. soli, LMG 27941T). For other species in the P. fluorescens lineage, one species was selected as the representative for each group. P. aeruginosa (P. aeruginosa group; P. aeruginosa lineage) was included as the outgroup to root the tree.

The four genes for MLSA were extracted from the genomes sampled. Each gene was aligned individually, then all four nucleotide alignments were concatenated for phylogenetic analysis. The concatenated alignment contains 9,912 aligned nucleotide sites. The maximum likelihood inference was performed using PhyML (Guindon et al. (2003)). The bootstrap support was assessed by 1,000 replicates.

Based on the multilocus molecular phylogeny (FIG. 1), 0617-T307 and all four P. soli strains with genome sequences available form a monophyletic clade with 100% bootstrap support. This result provided a strong support for assigning 0617-T307 to P. soli, a type strain which has been reported to be isolated from a soil sample from the Sierra Nevada National Park, Spai (Pascual et al. (2014))

Furthermore, based on the guidelines for Pseudomonas species assignation provided by García-Valdés and Lalucat ((García-Valdés et al. (2016)), additional support for assigning 0617-T307 to P. soli included: (a) 16S rDNA >98.7-99% identical. Compared to the type strain of P. soli, 0617-T307 shared 99.2% sequence identity. Compared to the sister species P. entomophila, 0617-T307 shared 99.5% sequence identity. Note that 16S rDNA is known to lack sufficient resolution power for species identification in Pseudomonas (García-Valdés et al. (2016); Peix et al. (2018)); (b) rpoD gene >95-96% identical. Compared to the type strain of P. soli, 0617-T307 shared 96.5% sequence identity. Compared to the sister species P. entomophila, 0617-T307 shared only 89.1% sequence identity; and (c) MLSA>97% identical. Compared to the type strain of P. soli, 0617-T307 shared 98.0% sequence identity. Compared to the sister species P. entomophila, 0617-T307 shared only 95.1% sequence identity.

### Example 2. Preparation, Isolation and Characterization of Rejuagro A and Rejuagro B from Ethyl Acetate Extracts of the Cell Broth of Strain 0617-T307

The preparation of RejuAgro A and B can be obtained by ethyl acetate extraction of the cell broth from the fermenter fermentation, followed by the chromatographic isolation and purification. Briefly, the stock bacterium Pseudomonas sp. 0617-T307 was streaked onto LB plate (Tryptone, 10 g/L; Yeast extract, 5 g/L; NaCl, 10 g/L; agar, 15 g/L; water) and grew in a 28° C. incubator for 24 h. For the preparation of seed media, single colony of 0617-T307was inoculated into a 2.0 L flask containing 500 mL autoclaved YME media (yeast extract, 4g/L; glucose 4 g/L and malt extract 10 g/L) and grow at 28° C. for 24 h in a shaking speed of 200 rpm. Then the seed media was inoculated into a 20 L NBS fermenter containing 12 L autoclaved YME media. The fermentation was proceeded at 16° C. for 1-7 days. The agitation speed and the airflow rate were 200 rpm and 2 L/min, respectively.

After harvesting, the bacterial culture was extracted by ethyl acetate for four times. The ethyl acetate layer was separated and dehydrated using sodium sulfate and dried by rotary evaporation at 35° C. This resulted 2.9 g crude extract from 12 L culture of strain 0617-T307.

The concentrated sample was dissolved in ethyl acetate and mixed with silica gel, which was packed as an injection column (φ3.0×20 cm) and mounted atop a silica gel Universal Column (4.8×18.5 cm) on a flash chromatography system (Yamazen AI-580) equipped with an UV detector. After loading the sample, the sample was eluted by the 280 mL of each of the following solvents in order with an increasing polarity, 100% hexane, 75% hexane/25% ethyl acetate, 50% hexane/50% ethyl acetate, 25% hexane/75% ethyl acetate, 100% ethyl acetate, 50% ethyl acetate/50% acetone, 100% acetone, and 100% methanol. The sample was eluted at a flow rate of 20 mL/min. The elute was monitored at UV 254 nm, and fractions were collected by a time mode at 20 mL/tubes. Totally, there are 114 fractions or tubes generated from the flash chromatography.

The generated fractions were applied for the subsequent plate assays. One mL of each fraction was picked up into a 1.5 mL test tube and vacuum dried by an Eppendorf vacuum concentrator. The dried sample was dissolved in 50 μL DMSO, of which 2 μL was used in the plate assay. Briefly, Erwinia amylovora 273 was streaked onto LB plate to grow at 28° C. incubator and single colony obtained after 24 h was inoculated into 5 mL LB media to allow an overnight growth at 28° C. shaker at 200 rpm. The bacteria were diluted 1:100 in sterile water, of which 225 μL was plated onto 50% LB plate (Tryptone, 5.0 g/L; Yeast extract, 2.5 g/L; NaC1, 5.0 g/L, Agar, 15 g/L). After dried in the biosafety cabinet for 10 mins, the DMSO solution of each fraction was then distributed to its pre-labeled section of the petri dish and allowed to dry for another 10 min. Along with the assay, DMSO and Kasugamycin were used as negative and positive controls, respectively. The plates were then incubated at 28° C. incubator and the inhibitory zone was checked one day later.

In vitro plate assay for the 114 fractions showed two fractions that inhibited the growth of E. amylovora 273. Notably, fractions/tubes 38-40 (which was abbreviated as T3840 or Flash-RejuAgro A), which were eluded by 50% hexane/50% ethyl acetate, had a relatively large zone of clearance that potently could be promising with further testing. The other bioactive compound in this assay was in fractions 50-52 (which was coded as T5052). These fractions were eluded by 25% hexane/75% ethyl acetate.

Preparative HPLC (Prep-HPLC) purification of the fraction 3840 and 5054 led to the discovery of 15 mg yellow-colored compound RejuAgro A (Rt17.5) and 103.3 mg dark-green colored compound RejuAgro B, respectively. RejuAgro A can be dissolved in methanol and chloroform. RejuAgro B (Rt10.5) does not dissolve well in methanol or chloroform, but it can be dissolved very well in dimethyl sulfoxide (DMSO) in a dark green color. The structures of the two compounds have been investigated by High-resolution mass spectrometry (HR-MS), infrared (IR), Ultraviolet (UV), 1D, and 2D Nuclear magnetic resonance (NMR), as well as X-ray crystal structure analysis. It showed that these two compounds are structurally similar, where the compound RejuAgro A contains 7 types of carbon groups (three types carbonyl, two types of tertiary carbons, two types of methyl carbons), but the RejuAgro B lacks one type of methyl group, as shown below:

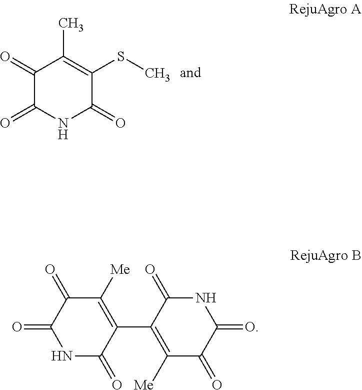 [SMILES: CSC1=C(C)C(=O)C(=O)NC1=O ; CC1=C(C2=C(C)C(=O)C(=O)NC2=O)C(=O)NC(=O)C1=O]

### Example 3. In vitro Antimicrobial Activity of RejuAgro A and RejuAgro B from Strain 0617-T307

The MIC values of RejuAgro A and RejuAgro B were determined for five types of bacteria: wild type gram-negative plant pathogenetic bacteria, streptomycin-resistant E. amylovora, fish disease causing bacteria, gram-positive and gram-negative human pathogenetic bacteria, and the producer of RejuAgro A (strain 0617-T307). The antimicrobial assay was performed according to the CLSI Antimicrobial Susceptibility Testing (AST) Standards. Briefly, the stock solution of each of the tested bacteria was streaked onto LB (Luria-Bertani) plate (tryptone, 10 g/L; yeast extract, 5 g/L; sodium salt, 10 g/L; Agar, 15 g/L). For special culture, NA (Nutrient broth+Agar) plate (beef extract, 3 g/L; yeast extract, 1 g/L; polypeptone, 5 g/L; sucrose, 10 g/L; and agar 15 g/L) was used for Xac. SHIEH (tryptone, 5 g/L; yeast extract, 0.5 g/L; sodium acetate, 0.01 g/L; BaCl₂ (H₂O)₂, 0.01 g/L; K₂HPO_{4, 0.1} g/L; KH₂PO₄, 0.05 g/L; MgSO₄: 7H₂O, 0.3 g/L; CaCl₂: 2H₂O, 0.0067 g/L; FeSO₄·7H₂O, 0.001 g/L; NaHCO₃, 0.05 g/L; agar, 10 g/L) and TYES (tryptone 4 g/L; yeast extract 0.4 g/L; MgSO₄, 0.5 g/L; CaCl₂ 0.5 g/L; pH to 7.2, agar, 15 g/L) were used for Flavobacterium columnare strains MS-FC-4 and #2, respectively. After that, the single colony from the plate was picked up and inoculated into the corresponding liquid media to grow overnight. The culture was diluted to OD₅₉₀=0.01 in LB or the corresponding media, and distributed at 200 μL/well in 96 well plates. The compound RejuAgro A and RejuAgro B and streptomycin was diluted and 4 μL of each concentration was added into each well to make a final concentration of 40 μg/mL, 20 μg/mL, 10 μg/mL, 5 μg/mL, 2.5 μg/mL, 1.25 μg/mL, 0.625 μg/mL, 0.3125 μg/mL, 0.15625 μg/mL, 0.078 μg/mL. The vehicle water (for streptomycin) or DMSO (for RejuAgro A and RejuAgro B) were used as control.

The assay results showed that RejuAgro A rather than RejuAgro B is the most active metabolite of strain 0617-T307. When compared with the effects on the gram-positive MRSA (MIC>40 μg/mL) and gram-negative E coli 0157: H7 (an important food-and waterborne pathogen that causes diarrhea, hemorrhagic colitis, and hemolytic-uremic syndrome (HUS) in humans) (MIC=40 μg/mL), RejuAgro A is specifically efficient against the tested bacteria, with the MIC values of 5-40 μg/mL. The antimicrobial activity of RejuAgro A is equivalent to streptomycin regarding the strain Erwinia amylovora 1189, Xanthomonas axonopodis pv. citri, Pseudomonas savastanoi pv. savastanoi, Pectobacterium parmentieri UPP163 936, Pectobacterium carotovorum subsp brasillensis 944, Pectobacterium carotovorum subsp. carotovorum wpp14 945, Dickeya dadantii 3937, which showed a MIC value of 5 μg/mL for E. amylovora, and 20-40 μg/mL for the other soft pathogenetic bacteria. The Xanthomonas bacteria are very sensitive to streptomycin, with a MIC value of 0.16 μg/mL, this is lower than the MIC value 5 μg/mL for RejuAgro A. The MIC value of RejuAgro A for Pseudomonas savastanoi pv. savastanoi is 40 μg/mL. The MIC value of RejuAgro A for Xanthomonas arboricola pv. Juglandis 219 is 6.25 μg/mL. The MIC value of RejuAgro A for Ralstonia solanacearum K60 and Pss4 is 3.13 and 6.25 μg/mL respectively. The MIC value of RejuAgro A for Clavibacter michiganensis subsp. michiganensis NCPPB382, Cmm 0317, Cmm 0690 is 6.25, 1.56, and 12.5 μg/mL respectively. The MIC value of RejuAgro A for Ralstonia solanacearum K60 and Pss4 is 40 μg/mL.

RejuAgro A was also tested against other E. amylovora strains that include one virulence E. amylovora and three streptomycin-resistant E. amylovora strains. RejuAgro A showed the same efficacy as streptomycin against E. amylovora 110 (MIC value 5 μg/mL). However, RejuAgro A is more efficient against E. amylovora 1189 than streptomycin. The MIC values of RejuAgro A and streptomycin to E. amylovora 1189 are 5 μg/mL and 10 μg/mL respectively. In addition, RejuAgro A is much more efficient against streptomycin-resistant E. amylovora CA11, DM1 and 898 as a lower MIC values (10 μg/mL) than the streptomycin's MIC values (>40 μg/mL) was observed for RejuAgro A. These results suggest that RejuAgro A is the most potent compound in the test against E. amylovora and represent a potential candidate for the replacement of streptomycin. There is no indication of cross resistance to RejuAgro A in streptomycin resistant strains.

Regarding the effects on the fish columnaris disease causing Flavobacterium, RejuAgro A has MIC values 5 μg/mL for Flavobacterium columnare strains MS-FC-4 and #2 (cause columnaris disease in wild and cultured fish), which is higher than the MIC values of streptomycin (0.31 μg/mL and 1.25 μg/mL for strain #2 and MS-FC-4, respectively).

The influence of RejuAgro A against strain 0617-T307 was tested. It showed that the MIC value of RejuAgro A against Pseudomonas soli 0617-T307 (the RejuAgro A producer) is larger than 40 μg/mL in the tested LB media, which means the strain 0617-T307can live and resistant to at least in 40 μg/mL RejuAgro A that produced by itself.

RejuAgro A was tested along with streptomycin against tomato pathogens (P. syringae. pv. tomato PT30, P. syringae. pv syringae 7046, P. syringae. pv. lachrymans 1188-1) and other citrus canker pathogens (Xanthomonas campestris pv. pruni, Xanthomonas campestris pv. vesicatoria XV-16). The MIC values of RejuAgro A against P. syringae are 40 μg/mL, while the streptomycin's MIC values are 2.5-5 μg/mL. Regarding to the X. campestris species, RejuAgro A's MIC values are 2.5 μg/mL or 40 μg/mL, which is smaller than the MIC values of streptomycin, which are 20 μg/mL or larger than 40 μg/mL. These displayed that when compared to the Pseudomonas caused tomato pathogens, Xanthomonas campestris pathogens are more sensitive to RejuAgro A than streptomycin.

RejuAgro A showed efficacy against all of tested pathogenic fungi (Table 1). RejuAgro A was tested against Phytophthora infestans, Venturia inaequalis and Mycosphaerella fijiensis. RejuAgro A showed 100% inhibition against P. infestans. and V. inaequalis. at 40 μg/mL, 80 μg/mL and 600 μg/mL (Table 1).

TABLE 1
Summary of the antimicrobial effect of RejuAgro A

| | MIC (μg/mL) | |
|---|---|---|
| Strain (related disease) | RejuAgro A | Streptomycin |
| Erwinia amylovora 1189 | 5 | 20 |
| (Fire blight on apples/pears) | | |
| Erwinia amylovora 110^{a} | 5 | 5 |
| (Fire blight on apples/pears) | | |
| Erwinia amylovora CA11^{b} | 10 | >40 |
| (Fire blight on apples/pears) | | |
| Erwinia amylovora DM1^{b} | 10 | >40 |
| (Fire blight on apples/pears) | | |
| Erwinia amylovora 898^{c} | 10 | >40 |
| (Fire blight on apples/pears) | | |
| Xanthomonas axonopodis pv. citri-Miami | 5 | 0.16 |
| XC2002-00010 (Citrus canker) | | |
| Xanthomonas axonopodis pv. citri N40-SO5 | 5 | 0.16 |
| (Citrus canker) | | |
| Methicillin-resistant staphylococcus aureus | >40 | 10 |
| USA300 (Skin infection, sepsis) | | |
| Pectobacterium parmentieri UPP163 936 | 40 | 40 |
| (Produce soft rot in multiple crops) | | |
| Pectobacterium atrosepticum 942 | 20 | 20 |
| (Produce soft rot in multiple crops) | | |
| Pectobacterium carotovorum subsp. | 40 | 40 |
| brasiliensis 944 (Produce soft rot in | | |
| multiple crops) | | |
| Pectobacterium carotovorum subsp. | 40 | 40 |
| carotovorum wpp14 945 (Produce soft rot | | |
| in multiple crops) | | |
| Dickeya dadantii 3937 | 40 | 20 |
| (Produce soft rot in multiple crops) | | |
| Pseudomonas savastanoi pv. savastanoi | 40 | 0.31 |
| (Olive knot) | | |
| E coli O157:H7 (Foodborne illness) | 40 | 20 |
| Flavobacterium columnare #2 | 5 | 0.31 |
| (Fish columnaris disease) | | |
| Flavobacterium columnare MS-FC-4 | 5 | 1.25 |
| (Fish columnaris disease) | | |
| Pseudomonas soli 0617-T307 | >40 | >40 |
| (RejuAgro A producer) | | |
| Pseudomonas syringae pv. tomato PT30 | 40 | 2.5 |
| (Tomato bacterial speck) | | |
| Pseudomonas syringae pv syringae 7046 | 20 | 2.5 |
| (Bacterial canker or blast (stone and | | |
| pome fruits)) | | |
| Pseudomonas syringae pv. lachrymans | 10 | 5 |
| 1188-1 (Angular Leaf Spot of Cucurbits) | | |
| Xanthomonas campestris pv. Pruni | 40 | >40 |
| (Bacterial Spot of Peach) | | |
| Xanthomonas campestris pv. vesicatoria | 2.5 | 20 |
| XV-16 (Tomato bacterial spot) | | |
| Xanthomonas arboricola pv. Juglandis 219 | 6.25 | 0.39 |
| (walnut blight) | | |
| Ralstonia solanacearum K60 (bacterial wilt) | 3.13 | 12.5 |
| Ralstonia solanacearum Pss4 (bacterial wilt) | 6.25 | 12.5 |
| Clavibacter michiganensis subsp. | 6.25 | 12.5 |
| michiganensis NCPPB382 | | |
| (Tomato canker) | | |
| Clavibacter michiganensis subsp. | 1.56 | 3.12 |
| michiganensis Cmm 0317 | | |
| (Tomato canker) | | |
| Clavibacter michiganensis subsp. | 12.5 | 12.5 |
| michiganensis Cmm 0690 | | |
| (Tomato canker) | | |
| Phytophthora infestans Pi 1306 | 40 | NA |
| (Potato late blight) | | |
| Phytophthora infestans Pi 88069 | 40 | NA |
| (Potato late blight) | | |
| Venturia inaequalis (Apple scab) | 80 | NA^{e} |
| Mycosphaerella fijiensis 10CR-25 | 600 | NA |
| (black sigatoka of Banana) | | |

^{a}Ea110 is the virulent strain used for the field trials in Michigan state;
^{b}Both CA11 and DM1 are streptomycin-resistant strains containing Tn5393 with the transposon on the acquired plasmid pEa34 and can grow in 100 μg/mL streptomycin containing media;
^{c}Ea898 is a spontaneous streptomycin-resistant strain with a mutation in the chromosomal rpsL gene and can grow in the media containing 2000 μg/mL streptomycin;
^{d}Copper resistant bacteria;
^{e}Positive control Copper solution at 1000 μg/mL inhibits 61% of the growth.

### Example 4. Production and Stability of RejuAgro A from Strain 0617-T307 in a Shaking-Flask Fermentation

The fermentation of 0617-T307 for the production and preparation of RejuAgro A can be obtained by two approaches, the shaking-flask fermentation and fermenter fermentation. The fermenter fermentation was described in Example 2. In this example, the flask fermentation can be obtained as below. The stock bacterium Pseudomonas sp. 0617-T307 was streaked onto YME agar plate (yeast extract, 4 g/L; glucose 4 g/L and malt extract 10 g/L; agar, 15 g/L) and grew at 28°° C. incubator for 24 h. The seed media were made by growing single colony of 0617-T307 in a 250 mL flask containing 50 mL sterile YME liquid media at 16° C. and 220 rpm for 24 h. Then the seed media were inoculated into 4 L flask containing 0.5 L sterile YME media at 4% ratio (v/v). Following the inoculation (2%, v/v) into eight 4-L flasks each containing 2 L YME media, the bacteria were grown at 16° C. in a shaker at 200-220 rpm for 1-7 days.

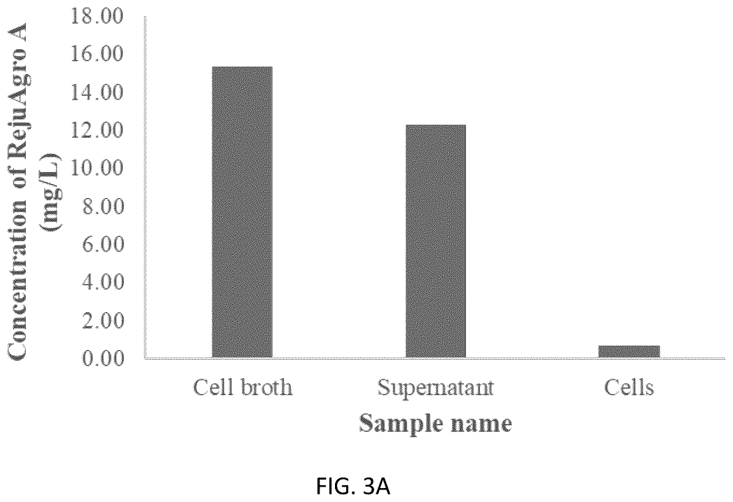

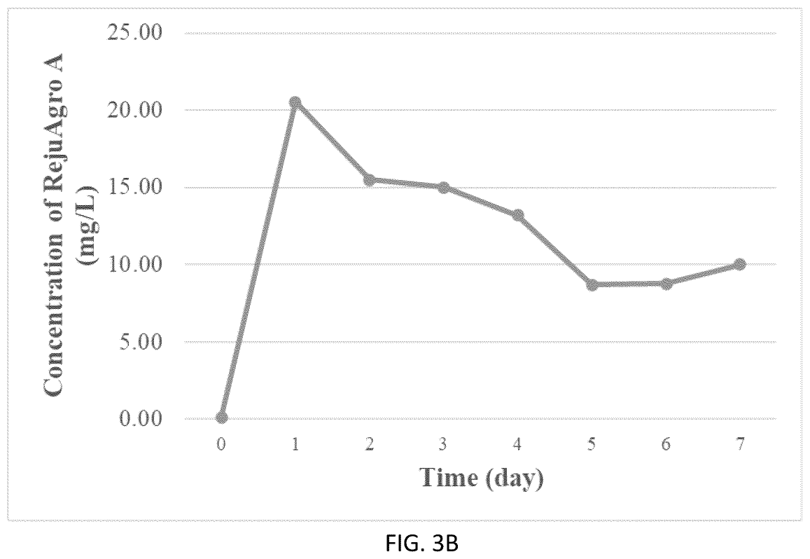

The RejuAgro A concentration was obtained by LC-MS analysis according to the developed standard curves. Two methods were used for the preparation of samples for LC-MS analysis. One approach is to extract the cell broth by ethyl acetate (1 mL:1 mL, vortex for 1 min), and to obtain the ethyl acetate extracts by centrifugation and vacuum drying of the ethyl acetate layer. The dried ethyl acetate extracts were dissolved in 40 μL methanol and 2 μL methanol solution was used for LC-MS analysis. The other method is to obtain the supernatant by centrifuging the cell broth, then mix the supernatant with equal volume of methanol to make the 50% methanol solution, of which 10 μL solution was injected into LC-MS. The second method was used because RejuAgro A production is an extracellular secretion process, which was demonstrated by the observation of the major amount of RejuAgro A in the supernatants rather than inside of the cells (FIG. 3A).

During the 7-day fermentation, the total production of RejuAgro A reached peak concentration on day one, then started to decrease with time increasing (FIG. 3B). Further detailed study on the production of RejuAgro A and the cell concentration were performed each 6 hours in shaking-flask fermentation. It showed that the concentration of RejuAgro A (total amount of RejuAgro A) reached to the maximum value of 13.8 mg/L at 18 h, and the concentration of bacteria cells reached to the maximum value of 2×10¹¹ CFU/mL at 12 h, which indicates the production of RejuAgro A is a cell growth-associated production process.

The volumes of the media in the 4-L shake-flasks affect the production of RejuAgro A. In the 4-L flasks with YME media, the production of RejuAgro A was only observed for the 500 mL volume size, and not observed for the 1.0 L or 1.5 L volume size. This observation indicates that the production of RejuAgro A prefers to occur in a highly aerated condition.

The media types and culture temperatures affect the production of RejuAgro A. LB media was tested in parallel with YME media at 16°° C. or 28° C. The production of RejuAgro A was observed in YME media but not in LB media at 16° C. Regarding the colony forming units, strain 0617-T307 grows well in LB media at both 16° C. and 28° C., and in YME media at 28° C. These results suggest that the production of RejuAgro A is both medium-specific and temperature-dependent. The activity for the products from 0617-T307 was monitored by plate assay against E. amylovora, which is consistent to the production of RejuAgro A.

To check the applicability of the production conditions for RejuAgro A, ten other Pseudomonas strains were tested under the same condition in parallel with the Pseudomonas strain 0617-T307. According to the analysis of housekeeping genes, 0917-T305, 0917-T306 and 0917-T307 were identified as Pseudomonas soli, and 0118-T319, 0318-T327 and 0418-T328 were identified as Pseudomonas mosselii. The type strains of both Pseudomonas. soli and Pseudomonas mosselii have been reported (Daboussi et al. (2002); Pascual et al. (2014)).

It showed that strain 0617-T307 and its phylogenetically closely related species can produce RejuAgro A in YME at 28° C. and 220 rpm. This result suggests that the method is specific for the strain 0617-T307 and some of its closely related species to produce RejuAgro A (Table 2). RejuAgro A can be present and stable in the culture at room temperature for at least 4 weeks, as tested by LCMS for 40-h culture obtained by growing 0617-T307 in YME media on a shaker at 16° and 220 rpm.

TABLE 2
Summary of RejuAgro A producing capabilities for the selected
Pseudomonas strains that were cultured in medium
YME at 16° C., 18 hours, 220 rpm.

| | | Production of |
|---|---|---|
| Strain code | Top-hit taxon | RejuAgro A |
| 0617-T307 | Pseudomonas soli | Yes |
| 0617-T318 | Pseudomonas protegens | No |
| 0817-T317 | Pseudomonas protegens | No |
| 0717-T327 | Pseudomonas koreensis | No |
| 0717-T314 | Pseudomonas koreensis | No |
| 0917-T305 | Pseudomonas soli | Yes |
| 0917-T306 | Pseudomonas soli | Yes |
| 0917-T307 | Pseudomonas soli | Yes |
| 0118-T319 | Pseudomonas mosselii | Yes |
| 0318-T327 | Pseudomonas mosselii | Yes |
| 0418-T328 | Pseudomonas mosselii | Yes |

### Example 5. Antimicrobial Activity of Cell Broth of Strain 0617-T307 Against 0617-T307 and E. amylovora.

Two assays were used for the antimicrobial test of 0617-T307 cell broth and metabolites. One is plate diffusion assay and the other one is microplate assay. LB plate was used for the plate diffusion assay of the antimicrobial activity of RejuAgro A containing fractions and cell broths against E. amylovora (Table 3). Both cell broth containing living cells of 0617-T307 and RejuAgro A containing suspension at 2 mg/mL showed the antimicrobial activity against E. amylovora. However, no inhibitory zone was observed when Serenade was applied.

TABLE 3
The activity of 0617-T307 cells and RejuAgro A
against E. amylovora in LB plates

| | Concentration | Diameter of the |
|---|---|---|
| Sample | (mg/mL) | Inhibitory zone (cm) |
| RejuAgro A | 2 | 1.1 |
| 0617-T307 cells | ND^{a} | 0.8 |
| RejuAgro B | 2 | 0 |
| Serenade | original solution | 0 |
| Streptomycin | 2 | 2.4 |
| Kasugamycin | | 1.3 |
| DMSO | | 0 |

^{a}The concentration of the bacterial cells was not determined.

To find a biological control recipe consisting both 0617-T307 cells and the active component RejuAgro A, the following experiments were done. The supernatant of the 40-h cell broth of 0617-T307 (abbreviated as ‘supernatant’) containing RejuAgro A was used for the antimicrobial assay against its producer 0617-T307. It showed that the strain 0617-T307 was able to grow in 2× dilution of supernatant in LB media rather than in YME media. Further study showed that the inhibitory effect of the supernatant is due to the lower pH value. Then the question 1 and 2 can be answered yes by controlling pH to 6.5˜6.8.

The bioactive fractions (crude extracts, 100 ug/mL; flash-RejuAgro A, 20ug/mL; HPLC-RejuAgro A, 10 μg/mL) were tested against strains 0617-T307, Ea and Xac. It showed that the bioactive fractions were not able to inhibit the growth of strain 0617-T307, which demonstrates RejuAgro A can be mixed with 0617-T307 cells for the preparation of biocontrol agents. The bioactive fractions containing RejuAgro A showed inhibitory effects against Ea and Xac, especially the flash-RejuAgro A and HPLC-RejuAgro A, almost abolish the growth of Ea and Xac under the tested conditions. This demonstrates that the RejuAgro A solution can be used for the biocontrol of fire blight and citrus cankers at 10-20 μg/mL.

### Example 6. Identification and Characterization of the Bioactive Metabolites From Ethyl Acetate Extracts of the Acidified Supernatant (pH 2.0) of Strain 0617-T307

The stock bacterium Pseudomonas sp. 0617-T307 was inoculated onto LB agar (Tryptone, 10 g/L; Yeast extract, 5 g/L; NaCl, 10 g/L; agar, 15 g/L; water) plate and grew at 28° C. incubator for 24 h. For the preparation of seed media, single colony of 0617-T307 was inoculated into 500 mL autoclaved YME media (yeast extract, 4 g/L; glucose 4 g/L and malt extract 10 g/L) and grow at 28° C. for 24 h in a shaking speed of 150 rpm. Then the seed media was inoculated into eight 4-L flasks each containing 2 L autoclaved YME media. The fermentation was proceeded at 16° C. in a shaker with a shaking speed of 150 rpm for 7 days.

After 7-day growth, the supernatants were obtained by centrifuging bacterial culture at 4000 rpm for 15 min. The pH of the supernatant was then adjusted to 2.0 by adding 6N HCl. The acidified supernatants were then subjected to the ethyl acetate extraction. This resulted 3.0 g crude extract from 14 L culture of strain 0617-T307.

The concentrated sample was dissolved in acetone and mixed with silica gel, which was loaded to a silica gel column (φ1003.0×20 cm) on a flash chromatography system (Yamazen AI-580) equipped with an UV detector. After loading the sample, the sample was eluted by the 280 mL of each of the following solvents in order with an increasing polarity, 100% hexane, 75% hexane/25% ethyl acetate, 50% hexane/50% ethyl acetate, 25% hexane/75% ethyl acetate, 100% ethyl acetate, 50% ethyl acetate 50% acetone, 100% acetone, and 100% methanol. The sample was eluted at a flow rate of 20 mL/min. The elute was monitored at UV 254 nm, and fractions were collected by a time mode at 20 mL/tubes. Totally, there are 114 fractions or tubes generated from the flash chromatography.

The generated fractions were applied for the subsequent plate assays. One mL of each fractions was picked up into a 1.5 mL test tube and vacuum dried by an Eppendorf vacuum concentrator. The dried sample was dissolved in 50 μL DMSO, of which 2 μL was used in the plate assay. Briefly, Erwinia amylovora 273 was inoculated into 50% LB (Tryptone, 5.0 g/L; Yeast extract, 2.5 g/L; NaCl, 5.0 g/L) plate and single colony will be inoculated into 5 mL LB media. The bacteria will be diluted 1:100 in sterile water, of which 225 μL was plated onto 50% LB plate. After dried in the biosafety cabinet for 10 mins, the DMSO solution of each fraction was then distributed to its pre-labeled section of the petri dish and allowed to dry for another 10 min. Along with the assay, DMSO and Kasugamycin were used as negative and positive controls, respectively. The plates were then incubated at 28° C. incubator and the inhibitory zone will be checked after one day.

In vitro plate assay for the 114 flash fractions indicated three bioactive fractions (T3234, T5058 and T7882) that inhibited the growth of E. amylovora 273. Fractions 3234 and 5258 showed relatively small zone of clearance. Fraction 3234 is eluded by 50% hexane/50% ethyl acetate. Fraction 5058 was eluted by 25% hexane/75% ethyl acetate. For the negative control, DMSO did not have a zone of inhibition and the positive control Kasugamycin did show a zone of inhibition. Another flash fraction T7882 was eluted by acetone/ethyl acetate (50%/50%). It inhibited the growth of E. amylovora activity as well.

Further anti-E. amylovora activity-guided HPLC isolation and purification identified two antimicrobial compounds (Rt22.9 and Rt25.0) from T5058 (see compound formulas 0617_T307_5058_Rt22.9 and 0617_T307_5058_Rt25.0), and one antimicrobial compound (Rt18.9) from T7882 (see compound formula 0617_T307_7882_Rt18.9). T307 5058_Rt22.9 and T307_5058_Rt25.0 are tryptophan derived natural products, and their structures were reported in Scifinder database but not the biological activities (Loots et al. (2015)). 0617_T307_7882_Rt18 was predicted to be a derivative of difuryl that has been reported previously (Osipov et al. (1978)). These natural products are depicted below:

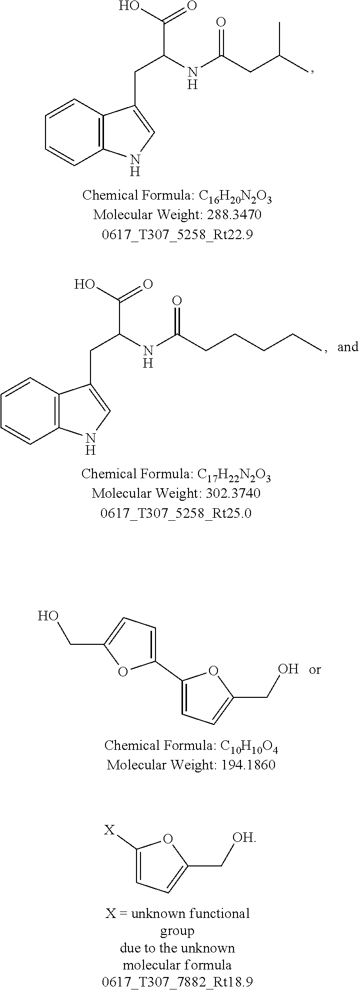

### Example 7. Identification of other Metabolites from Strain 0617-T307 using LCMSMS and Spectral Library Search

The crude extracts of non-pH adjusted cell broth and pH-adjusted cell broth (pH of the cell broth was adjusted to 2.0 by 6N HCl) was concentrated and resuspended in 250 μL 100% MeOH containing internal standard (m/z 311.08) and used for LC-MS/MS analysis. LC Injection Volume: 5 μL; LC Column: 1.7 μM C18, 100A, 50 X 2.1 mm Kinetex from Phenomenex C18 column with a 12 min gradient. 5-95% ACN on a Bruker Maxis Impact II. Data was acquired on a Bruker MaXis Impact II, UHR-QqTOF (Ultra-High Resolution Qq-Time-Of-Flight) mass spectrometry. Each full MS scan was followed by tandem MS (MS/MS) using collision-induced dissociation (CID) fragmentation of the eight most abundant ions in the spectrum. The scan rate was 3 Hz.

Exact spectral library search was then performed based on the bioinformatics analysis and molecule network analysis for the identification of new and known compounds. MS/MS spectra in samples were searched against the following spectral libraries, 1) GNPS Community Library; 2) FDA Library; PhytoChemical Library; 3) NIH Clinical Collections; 4) NIH Natural Products Library; 5) Pharamacologically Active NIH Small Molecule Repository; 6) Faulkner Legacy Library; 7) Pesticides; 8) Dereplicator Identified MS/MS Peptidic Natural Products; 9) PNNL Lipids; 10) Massbank; 11) Massbank EU; 12) MoNA; 13) ReSpect-Phytochemicals; 14) HMDB.

MS/MS spectra in samples were searched the above libraries and allowed to align with an offset to reference spectra. The match parameters were the same. These results can be explored to identify structural analogs of known compounds. MS/MS molecular network generated with minimum cluster size=2, minimum edge 0.7 cosine, 6 minimum matched peaks. As an example, the new molecule species at m/z 303.16 was identified to be corresponding to a new compound from the active fraction 0617-T307_5058 Rt25.0. Some of the known compounds were identified from the crude extract, which includes the Indole-3-carboxylic acid, a plant growth-promoting factor, and xantholysin A. It is reported that 1) the broad antifungal activity of P. putida BW11M1 is mainly dependent on Xantholysin production; 2) Xantholysin is required for swarming and contributes to biofilm formation (Li et al. (2013)). Indeed, the higher concentration of xantholysin A was observed by culturing 0617-T307, 0418-T328 and 0318-T327 at 28° C. So, except for the bioactive compound RejuAgro A, Xantholysin A is another contribution metabolite for the antimicrobial activity of the biocontrol bacteria 0617-T307 and its closely related species 0318-T3027 and 0418-T328.

### Example 8. Greenhouse and Field Infection Assays for Strain 0617-T307 and Some of its Closely Related Species that Produce RejuAgro A

To evaluate the biological control activity of 0617-T307 against Erwinia amylovora, we conducted an infection assay on crabapple trees at greenhouse of University of Wisconsin-Milwaukee. Biological control agent (0617-T307, 0717-T327, and 0617-T318) containing 1.0×10⁸ cfu per mL was sprayed onto the flowers (80% to full bloom) in multiple-tree plots. Briefly, the strain 0617-T307 was grown in 26 mL glass tube containing 5 mL LB media overnight, the cells were then inoculated (1:100) into LB media and grow on a shaker at 28° C. and 200 rpm for 14-18 h. Cells were harvested and resuspended in 10× water to reach 10⁸ CFU/mL. The resuspended solution can be used for greenhouse and field assay for fire blight control. Control flowers were sprayed with distilled water. All flowers were then inoculated by spraying 1.0×10⁶ cfu per mL E. amylovora strain Erwinia amylovora 273. Treatments with 0617-T307 were performed three times on September 7, October 9, and Oct. 19, 2018. Referring to Table 4, all spray treatments of 0617-T307 (Pseudomonas soli) provided 100% control of blossom blight symptom relative to 0% control of distilled water on the flowers of crabapple, suggesting that 0617-T307 is a promising biological control agent for fire blight caused by E. amylovora. The control rates of two other Pseudomonas spp, 0717-T327 (Pseduomonas koreensis) and 0617-T318 (Pseduomonas protegens) were low, with 16.7% and 25%, respectively. In conclusion, among the three Pseudomonas spp. we tested, only 0617-T307 show good control efficiency on fire blight of crabapple. We observed no phytotoxicity.

TABLE 4
Summary of greenhouse infection assay

| | Sep. 7^{th}, 2018 | | | Oct. 9^{th}, 2018 | | | Oct. 19^{th}, 2018 | | |
|---|---|---|---|---|---|---|---|---|---|
| | # of | # of | Control | # of | # of | control | # of | # of | Control |
| Biocontrol | flowers | infected | rate | flowers | infected | rate | flowers | infected | rate |
| agent | treated | flowers | (%) | treated | flowers | (%) | treated | flowers | (%) |
| Control | 8 | 8 | 0 | 16 | 16 | 0 | 18 | 18 | 0 |
| 0617-T307 | 3 | 0 | 100 | 9 | 0 | 100 | 10 | 0 | 100 |
| 0717-T327 | 6 | 5 | 16.7 | | | | | | |
| 0617-T318 | 4 | 3 | 25 | | | | | | |

For the field assay, biological control bacteria (0617-T307, 0118-T319, 0318-T327, 0418-T328; see Table 2) that produce RejuAgro A were applied on the flowers of the apple trees in the orchard on May 5th and May 6th of 2019 (40% and 70% bloom of apple flowers) at the concentration of 5×10⁸ CFU/mL. The bacterial pathogen E. amylovora Ea110 was inoculated on May 7th (90% bloom), at the concentration of 5×10⁶ CFU/mL. The percentage of diseased flower clusters for water control, streptomycin, 0617-T307, 0118-T319, 0318-T327, and 0418-T328 are 32.9%, 13.3%, 16.8%, 18.5%, 16.7%, and 11.8% respectively. Compared with streptomycin, the biocontrol bacteria that produce RejuAgro A have similar or better efficacy on controlling fire blight in the apple orchards.

### Example 9. Antifungal Activity of RejuAgro A and B and their Producers on Venturia Inaequalis

The fungus Venturia inaqualis that causes apple scab was maintained on PDA agar in the dark at room temperature (˜24° C.). A mixture of conidia and mycelia suspension (in 0.01 M PBS) was harvested from PDA (Potato dextrose agar). Ten μL the conidia and mycelia suspension were dropped onto biocontrol bacteria, RejuAgro A, or RejuAgro A amended plates. The control was PDA plates without the addition of the biocontrol bacteria or RejuAgro A or B. The dishes were incubated at room temperature in the dark and the diameter of each colony of V. inaqualis was checked 7 days later.

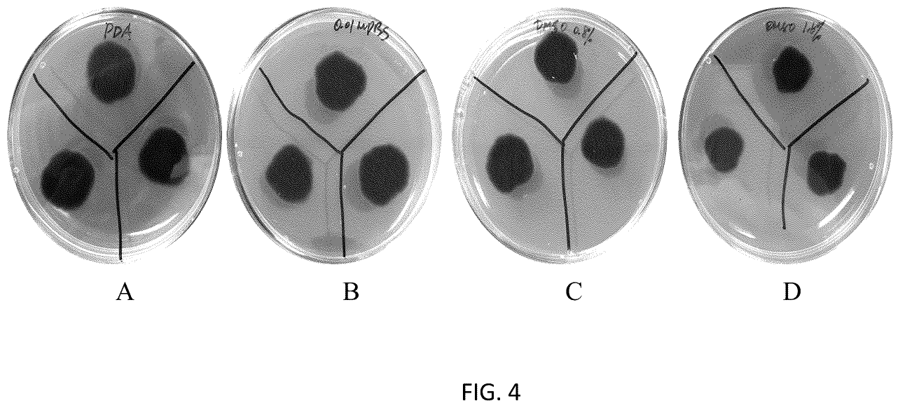

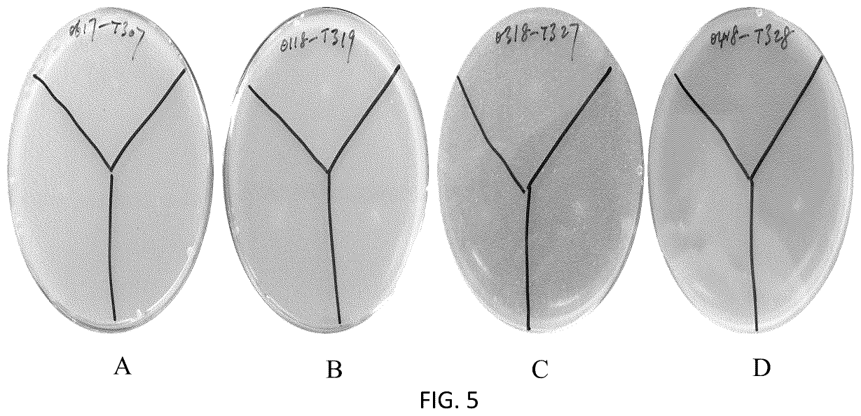

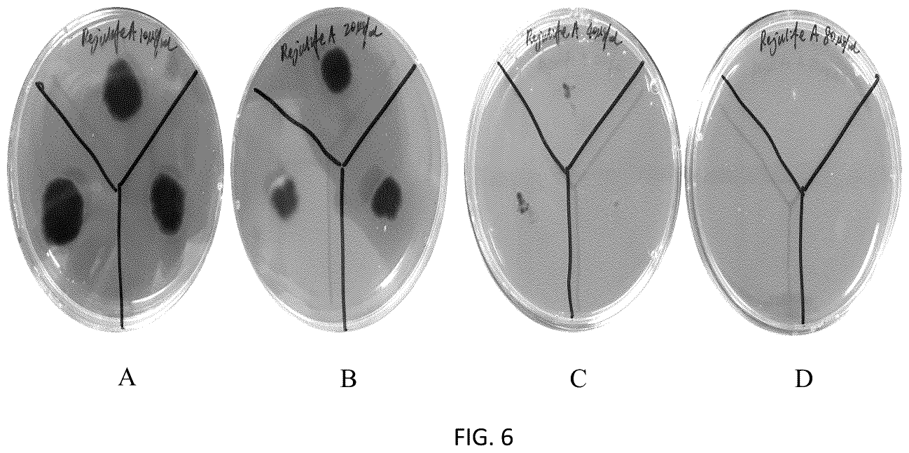

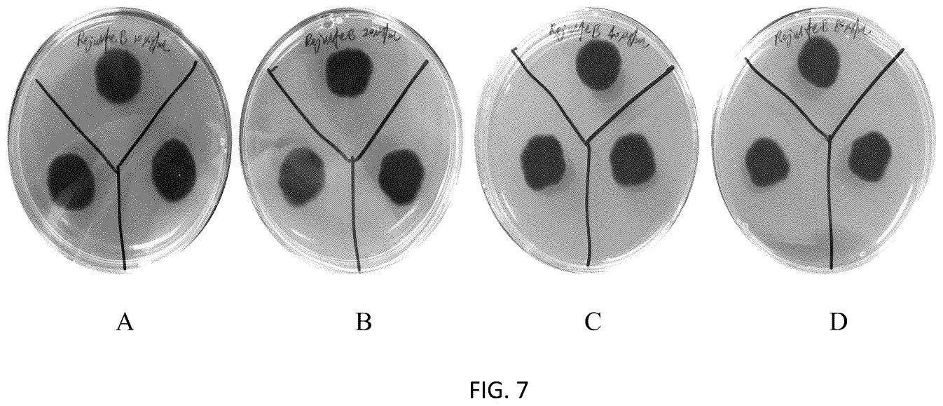

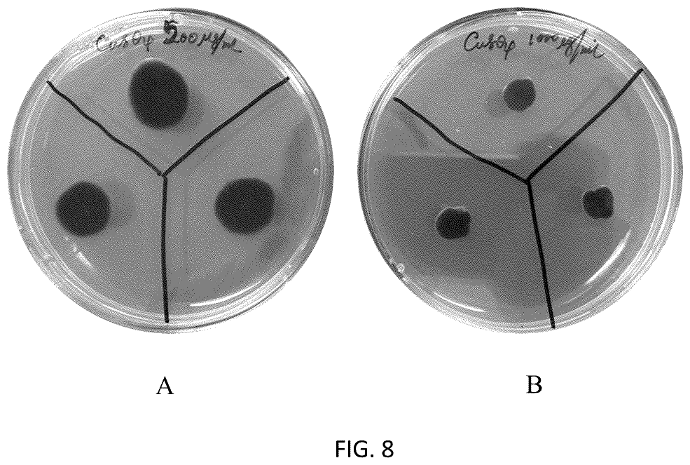

When comparing with the control (FIG. 4), the selected four biocontrol bacteria strains 0617-T307, 0118-T319, 0318-T327, and 0418-T328 can inhibit can inhibit the growth of V. inaequalis on PDA plate (FIG. 5); RejuAgro A can inhibit the growth of V. inaequalis on the PDA plate at 40-80 μg/mL (FIG. 6); However, the inhibitory effect of RejuAgro B on the growth of V. inaequalis was not observed on the PDA plate at 10-80 μg/mL (FIG. 7). Finally, no inhibition of V. inaequalis was observed on the PDA plate containing 200-1000 μg/mL copper sulfate (FIG. 8).

### Example 10. Production of RejuAgro A by Pseudomonas Species

The amounts of RejuAgro A were analyzed by HPLC-MS for the broth after 24 h. fermentation in 4 L flask containing 500 mL YME media at 16° C. and 220 rpm shaking.

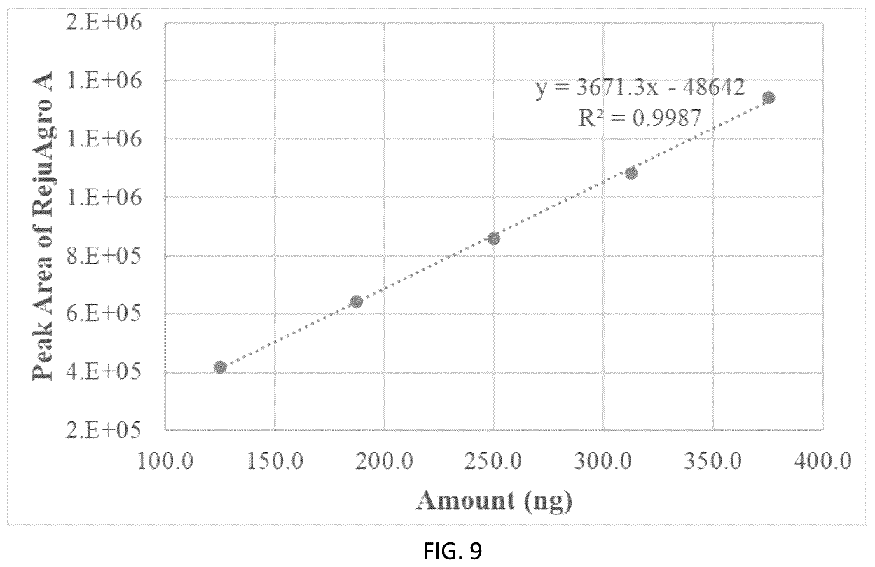

The amount-peak area curve was prepared for-investigation of the relationship between HPLC peak area and the amount of RejuAgro A (FIG. 9). Analytical method: 1) 25 mL cell broth was extracted with 25 mL ethyl acetate; 2) 5 mL ethyl acetate extract was dried and dissolved in 0.1 mL methanol; 3) 4 μL was injected into HPLC-MS.

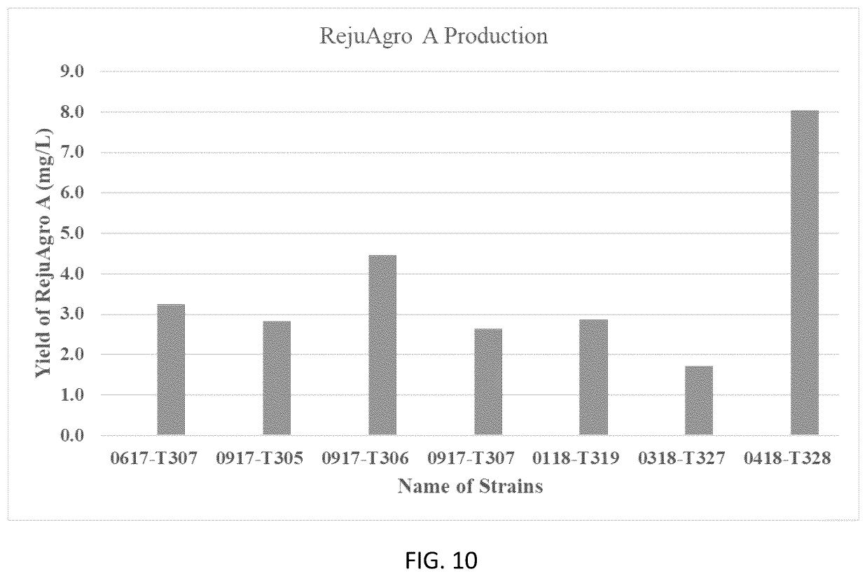

Seven bacteria (0617-T307, 0917-T305, 0917-T306, 0917-T307, 0118-T319, 0318-T327, 0418-T328) were evaluated for the production of RejuAgro A, the seed medium was prepared by growing the bacteria in YME medium at 16° C., 220 rpm for 24 h. HPLC analysis showed that all the seven bacteria produce RejuAgro A (FIG. 10).

### Example 11. Formulation and Greenhouse Assay of RejuAgro A

Formulation of RejuAgro A (solution, SL; see Table 5). Before applying to the flowers, 10 μg/mL was tank-mixed with 1% Polyethylene glycol (PEG) 4000 as safener agent. Later tests showed that 0.03% of polyvinyl alcohol (PVA) as safener agent achieved better protection of flowers. Alligare 90, a surfactant, can be added for increasing the efficacy (Table 6).

TABLE 5
Formulation of RejuAgro-A 1% SL^{a}

| Component | Ratio (%, w/w) | Grams | Notes |
|---|---|---|---|
| RejuAgro-A | 1 | 5 | Active |
| | | | ingredient |
| Alligare 90 | 10 | 50 | Wetting & |
| (Poly(Alkyl | | | spreading agent |
| EO/PO), etc.) | | | |
| Ethyleneglycol/ | 5 | 25 | Antifreeze |
| propyleneglycol | | | |
| PVA | 30 | 150 | Safener |
| Water | Balance | 270 | Carrier |
| | (add to 100%) | | |
| Total | 100 | 500 | |

^{a}A 1% solution (SL) of RejuAgro A formulation.

To evaluate the biological control activity of RejuAgro A against Erwinia amylovora, greenhouse infection assay on crabapples trees was conducted at the University of Wisconsin-Milwaukee. Ten μg/mL was supplemented with 1% Polyethylene glycol (PEG) 4000 or 1% PEG4000 (negative control) were applied on full bloom trees flowers 3 hours prior to the inoculation and 24 hours post-inoculation. Approximately 10⁸ CFU/mL of E. amylovora 110 strain resuspended in water was used as inoculum. The infection rate was calculated at around day 6 post inoculation. The experiments were conducted during the week of January 24-Jannuary 31, 2020. RejuAgro A can effectively suppress the blossom blight (Table 6).

TABLE 6
Blossom blight assay of RejuAgro A with 1% PEG 4000

| Treatment | Infection rate |
|---|---|
| 1% PEG4000 (negative control) | 50.8% |
| RejuAgro A with 1% PEG4000 10 μg/mL | 12.3% |
| Streptomycin 200 μg/mL | 5.7% |

### Example 12. Antifungal Activity of 0617-T307 Cell Broth Against Botrytis cinerea CA17.

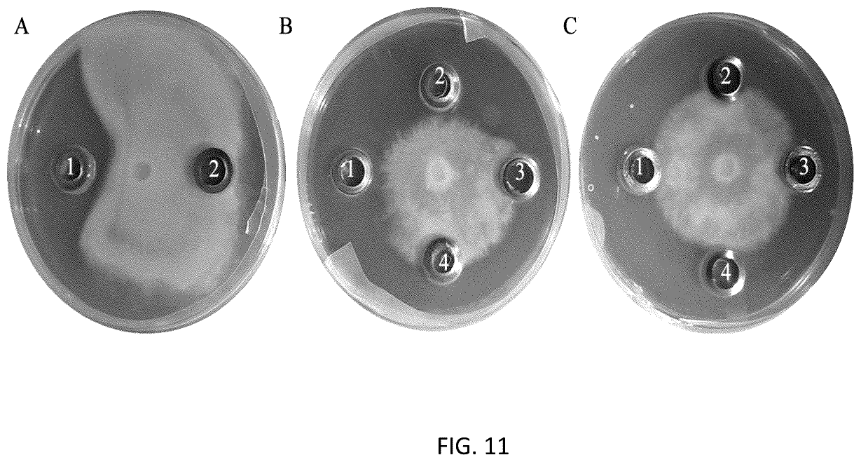

The seed of strain 0617-T307 was prepared by growing bacterial cells in YME media at 28°° C. and 180 rpm for 24 h. Then 4% (2 mL to 50 mL) was inoculated in to 250 mL flask containing 50 mL M8 (IAA medium) or M9 (CN medium) or M7 (PRN medium) or M6(DAPG medium) medium and grew at 28° C. and 180 rpm for 48 h. A volume of 0.5 mL of the cell broth was collected at 12 h and 24 h, and was stored in −20° C. freezer. For the antifungal assay, the cell broth was thawed and 5 μL was applied onto the sample wells on a PDA (potato dextrose agar) plate with equal radius distance to the central that is inoculated with the Botrytis cinerea (FIG. 11). It showed that the cell broth has antifungal activity against Botrytis cinerea CA17 on PDA (Potato Dextrose Agar) plates.

### Example 13. Antimicrobial Activity of crude extracts, RejuAgro A and RejuAgro B against Plant Pathogenic Bacteria

The metabolites of bacteria 0917-T305, 0318-T327 and 0418-T328 showed good efficacy against R. solanacearum, C. michiganensis subsp. Michiganensis, and X. arboricola pv. Juglandis (Table 7). The bacteria 0917-T305, 0318-T327 and 0418-T328 were grown in YME medium at 16 and 28° C. respectively. The natural product extracts from 0917-T305, 0318-T327 and 0418-T328 were prepared at 5 mg/mL and they were tested against three different plant pathogens: Ralstonia solanacearum, Clavibacter michiganensis subsp. michiganensis and Xanthomonas arboricola pv. Juglandis by plate diffusion assay. On agar plate diffusion assay, the metabolites of bacteria 0917-T305, 0318-T327 and 0418-T328, grown in YME at 16° C. and 28° C., showed relatively good efficacy against the tested R. solanacearum, C. michiganensis subsp. Michiganensis, and X. arboricola pv. Juglandis (Table 7). This demonstrates that along with RejuAgro A, other metabolites also have good efficacy against Ralstonia solanacearum, Clavibacter michiganensis subsp. michiganensis and Xanthomonas arboricola pv. Juglandis. RejuAgro B shows good efficacy against Ralstonia solanacearum (Table 7).

TABLE 7
Effects of bacterial crude extracts on the selected pathogenic
bacteria in plate assay

| | Bacterial | | X. arboricola | | R. | | C. michiganensis | | |
|---|---|---|---|---|---|---|---|---|---|
| Conc. | strain & | Medium | pv. Juglandis | | solanacearum | | subsp. Michiganensis | | |
| (mg/mL) | compounds | & Temp | Xaj219 | Xaj417 | K60 | Pss | Cmm382 | Cmm0317 | Cmm0690 |
| 5 | 0917-T305 | YME | 0^{a} | 0.2 | 0.5 | 0.5 | 0.5 | 0.5 | 0.5 |
| | crude extract | 16° C. | | | | | | | |
| 5 | 0318-T327 | YME | 0.2 | 0.4 | 0.5 | 1.0 | 0.7 | 0.7 | 0.8 |
| | crude extract | 28° C. | | | | | | | |
| 5 | 0418-T328 | YME | 0.2 | 0.4 | 0.5 | 1.0 | 0.7 | 0.8 | 0.8 |
| | crude extract | 28° C. | | | | | | | |
| 5 | 0318-T327 | YME | 0.1 | 0.4 | 0.7 | 0.6 | 0.5 | 0.3 | 0.4 |
| | crude extract | 16° C. | | | | | | | |
| 5 | 0418-T328 | YME | 0.2 | 0.4 | 0.8 | 0.9 | 0.5 | 0.5 | 0.5 |
| | crude extract | 16° C. | | | | | | | |
| 5 | Vancomycin | | | | | | 3.0 | 3.0 | 3.0 |
| 0.1 | Streptomycin | | 1.3 | 1.9 | 1.5 | 1.5 | | | |
| 2 | RejuAgro A | | 0.5 | 1.0 | 0.4 | 0.5 | | | |
| 2 | RejuAgro B | | 0.0 | 0.0 | 0.4 | 0.4 | | | |

^{a}Diameter of the zone of inhibition (cm)

### Example 14. Antimicrobial effect of Rt 18.9, Rt 22.9 and Rt 25.0

The stock bacterium Pseudomonas sp. 0617-T307 was inoculated onto an LB agar (Tryptone, 10 g/L; Yeast extract, 5 g/L; NaCl, 10 g/L; agar, 15 g/L; water) plate and grew at 28° C. incubator for 24 h. The fermentation and crude extracts preparation were performed same as described in Example 6.

The HPLC isolation and purification of the ethyl acetate extracts of acidified cell broth of Pseudomonas sp. 0617-T307 identified two antimicrobial compounds (Rt22.9 and Rt25.0) from flash fraction T5058 and one antimicrobial compound (Rt18.9) from flash fraction T7882. They were tested for their antimicrobial activities on bacterial strains listed in Table 8. Two μL of DMSO, Rt18.9, Rt22.9 or Rt25.0 were spotted on agar plates respectively grown with different bacterial strains and the inhibitory zone was further examined (Table 8).

TABLE 8
Antimicrobial effect of Rt 18.9, Rt 22.9 and Rt 25.0

| | | Rt 18.9 | Rt 22.9 | Rt 25.0 | Medium |
|---|---|---|---|---|---|
| Strains (related diseases)^{a} | DMSO | (5 mg/mL) | (10 mg/mL) | (5 mg/mL) | used^{b} |
| Clavibacter michiganensis | No | Yes | Yes | Yes | LB |
| subsp. michiganensis Cmm | | | | | |
| 0317 (Tomato canker) | | | | | |
| Pseudomonas syringae pv. | No | Yes | Yes | Yes | LB |
| lachrymans 1188-1 | | | | | |
| (Angular Leaf Spot of | | | | | |
| Cucurbits) | | | | | |
| Xanthomonas axonopodis | No | Yes | No | Yes | NA |
| pv. citri N40-SO5 (Citrus | | | | | |
| canker) | | | | | |
| Erwinia amylovora 1189 | No | Yes | No | No | LB |
| (Fire blight on apples/pears) | | | | | |
| Pectobacterium | No | Yes | No | Yes | LB |
| carotovorum subsp. | | | | | |
| brasiliensis 944 | | | | | |
| (Produce soft rot in | | | | | |
| multiple crops) | | | | | |
| Ralstonia solanacearum | No | Yes | Yes | Yes | LB |
| K60 (bacterial wilt) | | | | | |
| Xanthomonas arboricola | No | Yes | No | No | NA |
| pv. Juglandis 417 (walnut | | | | | |
| blight) | | | | | |
| Pseudomonas syringae pv. | No | Yes | Yes | Yes | LB |
| tomato PT30 (Tomato | | | | | |
| bacterial speck) | | | | | |
| Pectobacterium | No | Yes | No | No | LB |
| atrosepticum 942 (Produce | | | | | |
| soft rot in multiple crops) | | | | | |
| Pectobacterium parmentieri | No | Yes | No | No | LB |
| UPP163 936 (Produce soft | | | | | |
| rot in multiple crops) | | | | | |
| Pseudomonas savastanoi | No | Yes | Yes | Yes | LB |
| pv. savastanoi (Olive | | | | | |
| knot) 01-26 | | | | | |
| Pseudomonas syringae pv | No | Yes | Yes | Yes | LB |
| syringae 7046 (Bacterial | | | | | |
| canker or blast (stone and | | | | | |
| pome fruits) | | | | | |
| Xanthomonas arboricola | No | Yes | No | Yes | NA |
| pv. Juglandis 219 | | | | | |
| (walnut blight) | | | | | |
| Xanthomonas axonopodis | No | No | No | Yes | NA |
| pv. citri-Miami XC2002- | | | | | |
| 00010 (Citrus canker) | | | | | |

^{a}Inhibitory zone was examined between 2 to 5 days after spotted with DMSO, Rt 18.9, Rt 22.9 or Rt 25.0.
^{b}Agar medium plate used for growing the bacteria was either LB Medium (10.0 g/L Tryptone, 5.0 g/L Yeast extract, 10.0 g/L Sodium salt, 15.0 g/L Agar and tap water to final volume 1.0 L) or NA Medium (3.0 g/L Beef extract, 1.0 g/L Yeast extract, 5.0 g/L Polypeptone, 10.0 g/L Sucrose and 15 g/L Agar and tap water to final volume of 1.0 L)
Table 14.2 Medium composition of LB and NA agar plates

### Example 15. Antimicrobial effect of RejuAgro A on Mycosphaerella fijiensis

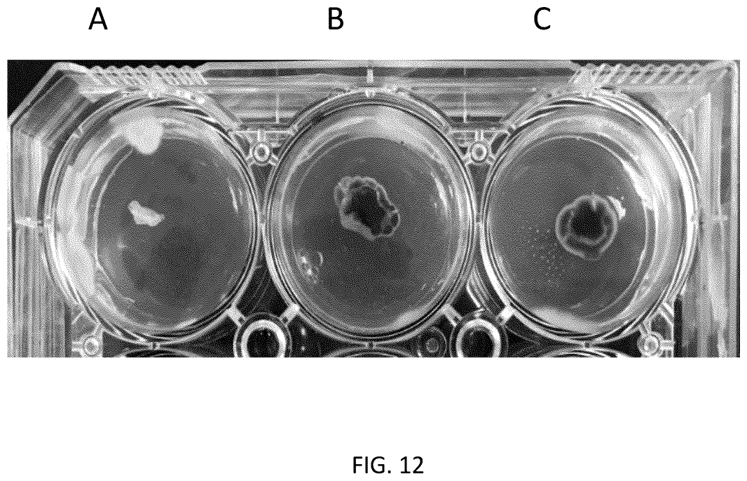

The antimicrobial effect of RejuAgro A on Mycosphaerella fijiensis was examined by adding final concentrations of 60 and 600 μg/mL of HPLC purified RejuAgro A respectively into the PDA agar medium. A 480 μL of 0.5 mg/mL or 5 mg/mL RejuAgro A was added into 3.52 mL of PDA in a well of a 6-well plate to make the final concentration of RejuAgro A at 60 (FIG. 12, middle well (panel A)) and 600 μg/mL (FIG. 12, left well (panel B)) respectively. The plate was gently shaken to let the compound dissolved. The 480 μL of water with 3.52 mL of PDA was used as control treatment (FIG. 12, right well (panel C). After the solidification of the agar, an agar piece grown with M. fijiensis was placed in the middle of the agar surface. A complete inhibition of the growth of M. fijiensis was observed in the treatment of RejuAgro A at the concertation of 600 μg/mL two weeks post-inoculation (FIG. 12).

### Example 16. Antimicrobial effect of RejuAgro A on Xanthomonas oryzae pv. oryzicola (Xon507)

The antimicrobial effect of RejuAgro A on Xanthomonas oryzae pv. oryzicola (Xon507) was examined. The X. oryzae pv. oryzicola (Xon507) bacterial suspension (OD₆₀₀=0.3) was sprayed on PSG agar plates. The paper discs, loaded with 50 μL loading volume of the HPLC purified aqueous RejuAgro A at the concentrations of 5.5 μg/mL, 11.1μg/mL, 22.1 μg/mL, 33.2 μg/mL, 55.4 μg/mL, 110.7 μg/mL respectively, were put on the agar plates and the inhibition zone was measured 44 hours after placing the paper discs on the agar plates. An inhibition was observed at all concentrations of the paper discs soaked with RejuAgro A suspension (Table 9).

TABLE 9
Antimicrobial effect of RejuAgro A on Xanthomonas oryzae pv. oryzicola (Xon507).

| Concentration of | Water | 5.5 | 11.1 | 22.1 | 33.2 | 55.4 | 110.7 |
|---|---|---|---|---|---|---|---|
| RejuAgro A | control | μg/mL | μg/mL | μg/mL | μg/mL | μg/mL | μg/mL |
| Inhibition zone | 0 | 0.27 ± | 0.5 ± | 0.73 ± | 0.83 ± | 0.93 ± | 1.33 ± |
| (cm) | | 0.06 | 0.1 | 0.15 | 0.15 | 0.06 | 0.12 |

### Example 17. Antimicrobial effect of RejuAgro A on Xanthomonas citri pv. citri citrange (XW19)

The antimicrobial effect of RejuAgro A on Xanthomonas citri pv. citri citrange (XW19) was examined. The bacterial suspension (OD₆₀₀=0.3) of X. citri pv. citri citrange (XW19) was sprayed on PSG agar plates. The paper discs, loaded with 50 μL loading volume of the HPLC purified aqueous RejuAgro A at the concentrations of 5.5 μg/mL, 11.1 μg/mL, 22.1 μg/mL, 33.2 μg/mL, 55.4 μg/mL, 110.7 μg/mL respectively, were put on the agar plates and the inhibition zone was measured 44 hours after placing the paper discs on the agar plates. An inhibition was observed at the concentrations of 55.37 μg/mL and 110.74 μg/mL of RejuAgro A (Table 10).

TABLE 10
Antimicrobial effect of RejuAgro A on Xanthomonas citri pv. citri citrange (XW19).

| Concentration of | Water | 5.5 | 11.1 | 22.1 | 33.2 | 55.4 | 110.7 |
|---|---|---|---|---|---|---|---|
| RejuAgro A | control | μg/mL | μg/mL | μg/mL | μg/mL | μg/mL | μg/mL |
| Inhibition zone | 0 | 0 | 0 | 0 | 0 | 0.23 ± | 0.27 ± |
| (cm) | | | | | | 0.06 | 0.12 |

### Example 18. Media Culture Compositions used in the Examples

Table 11 includes exemplary media compositions used in the Examples.

TABLE 11
Media compositions.

| No. | Medium Name | Composition | g per liter | | pH at 25° C. | Reference |
|---|---|---|---|---|---|---|
| M1 | YME | Yeast extract | 4.0 | g | NA | (Hamamoto, H., et. al. |
| | | Malt extract | 10 | g | | (2015)) |
| | | Glucose | 4.0 | g | | |
| | | Tap water | 1.0 | L | | |
| M6 | DAPG | Malt extract | 15.0 | g | NA | (Gnanamanickam, |
| | medium | Water | | | | Samuel S. (2008)) |
| M7 | PRN | Glycerol | 30.0 | g | NA | (Gnanamanickam, |
| | medium | K₂HPO₄ | 3.0 | g | | Samuel S. (2008)) |
| | | NaCl | 5.0 | g | | |
| | | MgSO₄ • 7 H₂O | 0.5 | g | | |
| | | D-tryptophan | 0.61 | g | | |
| M8 | IAA | D-glucose | 5.0 | g | NA | (Gnanamanickam, |
| | medium | Casamino acids | 25.0 | g | | Samuel S. (2008)) |
| | | MgSO₄ • 7 H₂O | 0.3 | g | | |
| | | K₂HPO₄ | 1.7 | g | | |
| | | NaH₂PO₄ | 2.0 | g | | |
| M9 | CN | Casamino acids | 10.0 | g | NA | (Gavrish, E., et al. |
| | | Nutrient broth | 10.0 | g | | (2008)) |

### Example 19. Bacterial Strains, Natural Products, and References Cited to Same

The bacterial strains and natural products described in this application and presented in the appended claims are well-known in the microbiology literature. These references are presented below in Table 12 for each of the cited bacterial strains and natural products disclosed herein, the contents of which are hereby incorporated by reference in their entirety.

TABLE 12
Bacterial strains, natural products and references
cited in support as evidence of their availability.

| Bacterial Strains | Reference citation |
|---|---|
| 0617-T307, 0917-T305, | Pascual, J., Garcia-López, M., Carmona, C., Sousa, T. da |
| 0917-T306, and | S., de Pedro, N., Cautain, B., Martin, J., Vicente, F., |
| 0917-T307 | Reyes, F., Bills, G. F., & Genilloud, O. (2014). |
| | Pseudomonas soli sp. nov., a novel producer of |
| | xantholysin congeners. Syst Appl Microbiol, 37: 412-416. |
| 0118-T319, | Dabboussi, F., Hamze, M., Singer, E., Geoffroy, V., |
| 0318-T327, | Meyer, J., & Izard, D. (2002). Pseudomonas mosselii sp. |
| and 0418-T328 | nov., a novel species. Int J Syst Bacteriol, 52: 363-376. |
| Natural Products | Reference citation |
| RejuAgro B | Knackmuss, H., Medizinische, M., & Chemie, I. (1968). |
| | Methyl-substituted 2,3,6-trihydroxypyridines and their |
| | oxidation products. Eur. J. Inorg. Chem. 2689: 2679- |
| | 2689. |
| Rt 22.9 and Rt 25.0 | Loots, D. T., Erasmus, E., & Mienie, L. J. (2005). |
| | Identification of 19 new metabolites induced by |
| | abnormal amino acid conjugation in isovaleric acidemia. |
| | Clin Chem, 51: 1510-1512. |
| Rt 18.9 | Osipov, A. M., Metlova, L. P., Baranova, N. V, & |
| | Rudakov, E. S. (1978). New derivatives of difuryl: |
| | 2,2′-difuryl-5,5′-dicarbinol and 2,2′-difuryl-5,5′- |
| | dicarboxylic acid. Ukrainskii Khimicheskii Zhurnal |
| | (Russian Edition), 44: 398. |

### Example 20. Examples of Fungal Pathogen treatments with RejuAgro A

### 20.A Pythium aphanidermatum

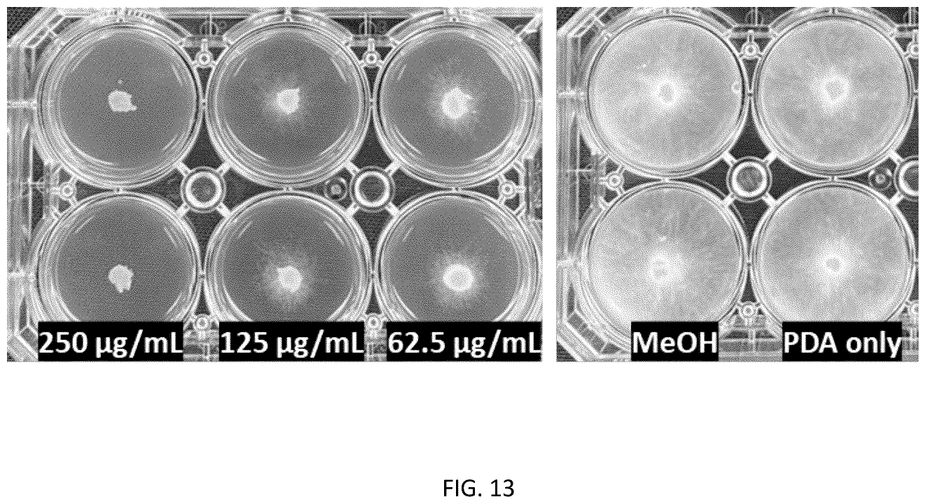

For the pathogen assay to evaluate the efficacy of Formula (I) (RejuAgro A) against Pythium aphanidermatum, the following methodology was employed: P. aphanidermatum was cultured on PDA plates at room temperature (22° C.) for four days. After the incubation period, an agar plug containing P. aphanidermatum mycelial growth was transferred to each PDA plate amended with Formula (I) (RejuAgro A). Plates containing methanol were used as negative controls. All plates were incubated at room temperature (22°° C.) for an additional two days, after which the diameter of the P. aphanidermatum mycelial growth was measured to assess fungal inhibition. At a concentration of 62.5 μg/mL, Formula (I) (RejuAgro A) displayed an inhibitory effect on the growth of P. aphanidermatum mycelia, as evidenced by the noticeably reduced colony size (FIG. 13).

### 20.B Podosphaera xanthii

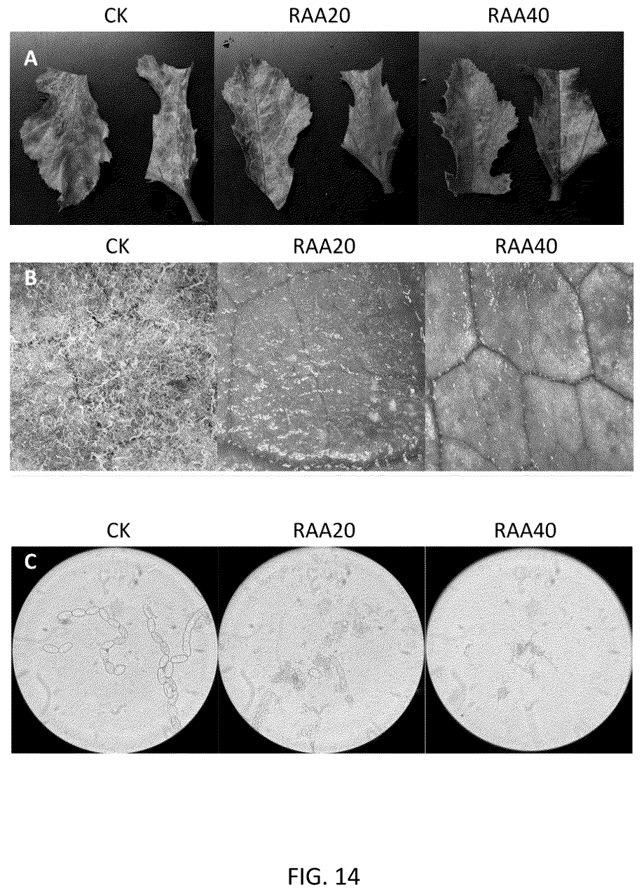

Leaves of zucchini infected with powdery mildew (Podosphaera xanthii) were collected for evaluation. Formula (I) (RejuAgro A) was prepared at concentrations of 20 μg/mL and 40 μg/mL in water and sprayed on the infected leaves, with water-only treatment serving as the control. The treated leaves were placed in a sealed plastic box containing a water-soaked paper towel to maintain humidity, and the box was kept at room temperature (22°° C.) for two days. After the treatment period, symptoms of powdery mildew were observed. The results demonstrated that Formula (I) (RejuAgro A) at both 20 μg/mL and 40 μg/mL significantly reduced disease symptoms (FIG. 14). The pathogen's mycelium was notably reduced, appearing flattened and showing a loss of typical mycelial structures, indicating effective inhibition of Podosphaera xanthii mycelial structures, indicating effective inhibition of P. xanthii.

### 20.C Plasmopara viticola

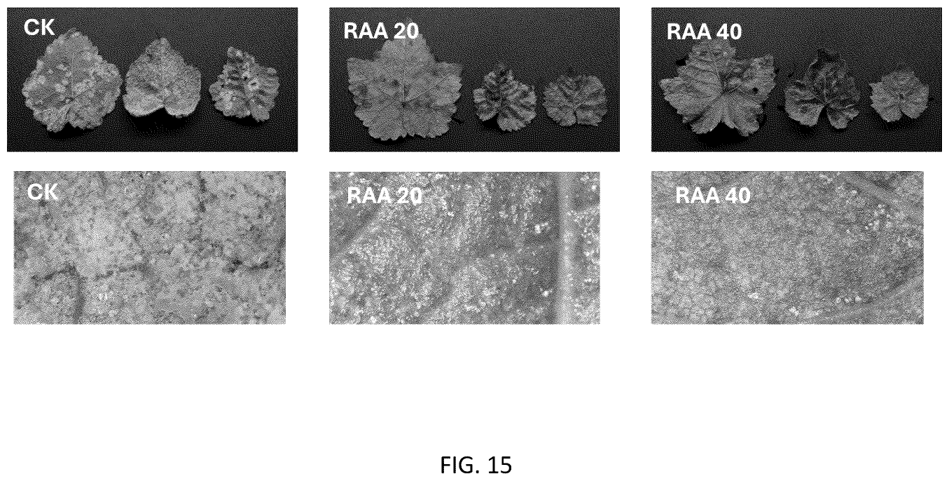

Leaves of grapevine infected with downy mildew (Plasmopara viticola) were collected for evaluation. Formula (I) (RejuAgro A) was prepared at concentrations of 20 μg/mL and 40 μg/mL in water and sprayed on the infected leaves, with water-only treatment serving as the control. The treated leaves were placed in a sealed plastic box containing a water-soaked paper towel to maintain humidity, and the box was kept at room temperature (22° C.) for two days. After the treatment period, symptoms of downy mildew were observed. The results demonstrated that Formula (I) (RejuAgro A) at both 20 μg/mL and 40 μg/mL significantly reduced disease symptoms (FIG. 15). The pathogen's mycelium was notably reduced, turning brown and degraded, with visible disruption to the typical downy mildew structures, indicating effective inhibition of Plasmopara viticola.

20.D Erysiphe cichoracearum

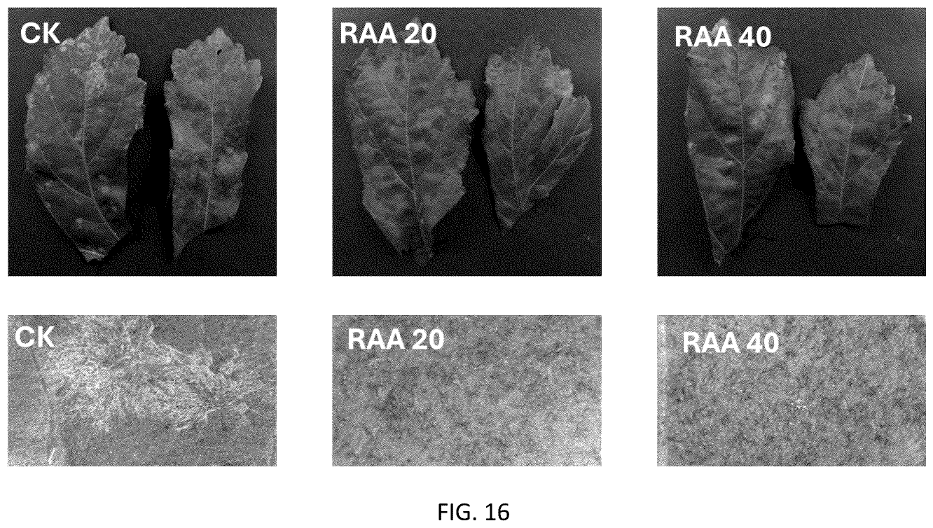

Leaves of okra infected with powdery mildew (Erysiphe cichoracearum) were collected for evaluation. Formula (I) (RejuAgro A) was prepared at concentrations of 20 μg/mL and 40 μg/mL in water and sprayed on the infected leaves, with water-only treatment serving as the control. The treated leaves were placed in a sealed plastic box containing a water-soaked paper towel to maintain humidity, and the box was kept at room temperature (22° C.) for two days. After the treatment period, symptoms of powdery mildew were observed. The results demonstrated that Formula (I) (RejuAgro A) at both 20 μg/mL and 40 μg/mL significantly reduced disease symptoms (FIG. 16). The pathogen's mycelium was notably reduced, appearing flattened and showing a loss of typical mycelial structures, indicating effective inhibition of Erysiphe cichoracearum.

20.E Pseudoperonospora cubensis on Cucumbers

Cucumber seeds (‘Diamondback’) were sown in 5′×22′ raised, plastic-mulched beds with double drip irrigation. Plants were grown under conditions simulating commercial cucumber production in Florida. The trial area was fertilized with 1,000 lbs/acre of granular Jun. 7, 2010 fertilizer, supplemented by liquid 8-0-8 injected through the drip system. The fertilizer was incorporated into the soil before forming the raised beds. Foliar applications of Formula (I) (RejuAgro A) and Ranman, using a CO₂-powered backpack sprayer, were performed at 21, 29, 50, and 56 days after sowing the cucumber seeds. Concentrations of 20 ug/mL and 40 ug/mL were applied. Disease severity was assessed 62 days after sowing using a modified Horsfall-Barrett scale, and AUDPC was calculated. No phytotoxicity was observed. All data were analyzed using ARM 2024.2 software, and results were compared by ANOVA and LSD tests (P=0.1). This field trial demonstrated that Formula (I) (RejuAgro A) can be a reliable solution for managing Pseudoperonospora cubensis in cucumbers, reducing disease incidence while maintaining plant health two months after sowing the cucumber seeds (Table 13). The results suggest that Formula (I) (RejuAgro A) can provide an alternative to conventional fungicides, addressing the need for sustainable disease management in agriculture.

TABLE 13
Severity of Downey Mildew cucumber field assay
after treatments with RejuAgro A (Formula I).

| | RejuAgro A | RejuAgro A | Ranman | Untreated |
|---|---|---|---|---|
| Treatment | (20 ppm) | (40 ppm) | (210 ml/ha) | control |
| Downey Mildew incidence | 20% b | 15% b | 30% b | 75% a |

*Means followed by same letter or symbol do not significantly differ (P = .10, LSD)

20.F Clarireedia jacksonii on Turfgrass

The efficacy of RejuAgro A (Formula I) was evaluated against Clarireedia jacksonii, the pathogen responsible for dollar spot in turfgrass. Two concentrations, 100 ppm and 250 ppm, were tested using a 50 mg/mL stock solution prepared in methanol. Potato dextrose agar (PDA) served as the culture medium, with unamended PDA and methanol-amended PDA used as controls. The required volumes of RejuAgro A were prepared using the dilution equation. The media was autoclaved, cooled, and then amended with either RejuAgro A or methanol. A 5 mm mycelial plug of C. jacksonii was placed in the center of each plate, which was sealed and incubated at room temperature. Mycelial growth was measured after 72 hours. RejuAgro A significantly inhibited C. jacksonii growth in a concentration-dependent manner, with 100 ppm and 250 ppm showing reductions in colony size of 29.43% and 71.01%, respectively, compared with unamended PDA (Table 14). Minimal inhibition was observed in the methanol-amended control.

TABLE 14
In vitro plate assay of RejuAgro A (Formula I) against
Clarireedia jacksonii.

| RAA sensitivity | | | Methanol sensitivity | | | |
|---|---|---|---|---|---|---|
| | Average | % | | Average | % | % growth |
| Concentration | diameter | Growth | Concentration | diameter | Growth | inhibition |
| (ppm) | (mm) | Inibition | (ppm) | (mm) | Inibition | by RAA |
| 0 | 75.89 | 0.00 | 0% | 75.89 | 0.00 | 0.00 |
| 100 | 53.56 | 29.43 | 0.2% | 72.67 | 4.25 | 25.18 |
| 250 | 22.00 | 71.01 | 0.5% | 65.67 | 13.47 | 57.54 |

20.G Microdochium nivale on Turfgrass

The same concentrations of RejuAgro A (100 ppm and 250 ppm) were tested against Microdochium nivale, the pathogen responsible for pink snow mold in turfgrass. PDA media was prepared and amended with RejuAgro A at the same concentrations, while unamended PDA and methanol-amended PDA served as controls. Following inoculation with a 5 mm mycelial plug of M. nivale, the plates were sealed and incubated at room temperature. Mycelial growth was measured after 96 hours. RejuAgro A demonstrated strong inhibition of M. nivale, with 100 ppm and 250 ppm reducing fungal growth by 60.49% and 81.17%, respectively, compared with unamended PDA (Table 15). Methanol alone produced little inhibition at corresponding concentrations.

TABLE 15
In vitro plate assay of Formula I (RejuAgro A) against
Microdochium nivale

| RAA sensitivity | | | Methanol sensitivity | | | |
|---|---|---|---|---|---|---|
| | Average | % | | Average | % | % growth |
| Concentration | diameter | Growth | Concentration | diameter | Growth | inhibition |
| (ppm) | (mm) | Inibition | (ppm) | (mm) | Inibition | by RAA |
| 0 | 36.00 | 0.00 | 0% | 36.00 | 0.00 | 0.00 |
| 100 | 14.22 | 60.49 | 0.2% | 37.44 | −4.01 | 60.49 |
| 250 | 6.78 | 81.17 | 0.5% | 35.89 | 0.31 | 80.86 |

20.H Podosphaera leucotricha on Apple

A field trial was conducted at Cornell AgriTech, Geneva, New York, in 2024 to evaluate the effectiveness of Formula (I) (RejuAgro A) in controlling powdery mildew, Podosphaera leucotricha, on 21-year-old ‘Gala’ apple trees. The treatments were applied using a backpack sprayer calibrated to deliver 100 gallons per acre, beginning at the green tip stage (6 Apr. 2024) and continuing through to the second cover spray (29 May 2024). The results demonstrated a significant reduction in the incidence of powdery mildew lesions on terminal leaves. In untreated control plots, the incidence of powdery mildew was 8.6%, while Formula (I) (RejuAgro A) treatments at concentrations of 20 parts per million and 40 parts per million reduced the incidence to 1.3% in both treatment groups, (Table 16) indicating a substantial improvement in disease management.

TABLE 16
Field assay of formulated biocontrol, RejuAgro, on apple field.
Evaluation of RejuAgro for control of powdery mildew on 21-year-old
‘Gala’ apples in 2024 at Cornell University, AgriTech, Geneva, NY

| | | | Incidence of |
|---|---|---|---|
| | | | powdery mildew |
| | | | lesions on terminal |
| Treatment programs (amt./A) | | Timing* | leaves (%)** |
| 1 | Untreated | na. | 8.6 ± 0.4 a |
| 2 | Kocide 3000 6 1b | 1 | 1.3 ± 0.0 b |
| | Captec 2 qt+ Manzate Max 2.4 qts | 2, 4, 5 | |
| | RAA 20 ppm, RAA 50 g + 10 L water + 12 ml Regulaid + | 3, 6-8 | |
| | 12 grams citric acid | | |
| 3 | Kocide 3000 6 lb | 1 | 1.3 ± 0.0 b |
| | Captec 2 qt+ Manzate Max 2.4 qts | 2, 4, 5 | |
| | RAA 40 ppm, RAA 100g + 10 L water + 12 ml Regulaid + | 3, 6-8 | |
| | 12 grams citric acid | | |
| 4 | Kocide 3000 6 1b | 1 | 0.0 ± 0.0 b |
| | Captec 4L 2 qt + Manzate Max 2.4 qt | 2, 3, 5, 7 | |
| | Aprovia 5.0 fl oz | 4 | |
| | Flint Extra 3 fl oz | 6 | |
| | Cevya 5 fl oz | 8 | |
| 5 | Kocide 3000 6 1b | 1 | 0.0 ± 0.0 b |
| | Captec 4L 2 qt + Manzate Max 2.4 qt | 2 | |
| | Double Nickel 2 Qts | 3, 5, 7 | |
| | Aprovia 5.0 fl oz | 4 | |
| | Flint Extra 3 fl oz | 6 | |
| | Cevya 5 fl oz | 8 | |

*Applications timing were 6 Apr-green tip (application 1); 13 Apr-half-inch green (application 2); 19 Apr-tight cluster (application 3); 25 April-pink (application 4); 3 May-bloom (application 5); 9 May-petal fall (application 6); 20 May-1st cover (application 7); 29 May-2nd cover (application 8).
**All values are disease incidence and the means and standard errors of at least 10 sets of cluster leaves or 10 fruit collections across four replicate trees. Values within columns followed by the same letter are not significantly different (P < 0.05) according to LSMEANS procedure in SAS 9.4 with an adjustment for Tukey's HSD to control for family-wise error.

### CITATIONS

Adaskaveg J E, Förster H & Wade M L (2010) Effectiveness of Kasugamycin against Erwinia amylovora and its potential use for managing fire blight of pear. Plant Disease 95:448-454.
Aldwinckle H. S., Bhaskara Reddy M. V., Norelli J. L. (2002) Evaluation of control of fire blight infection of apple blossoms and shoots with sar inducers, biological agents, a growth regulator, copper compounds, and other materials, International Society for Horticultural Science (ISHS), Leuven, Belgium. pp. 325-331.
Alsohim A. S., Taylor T. B., Barrett G. A., Gallie J., Zhang X. X., Altamirano-Junqueira A. E., Johnson L. J., Rainey P. B., Jackson R. W. (2014) The biosurfactant viscosin produced by Pseudomonas fluorescens SBW25 aids spreading motility and plant growth promotion. Environ Microbiol 16:2267-81.
Biondi E., Bazzi C., Vanneste J. L. (2006) Reduction of fire blight incidence on apple flowers and colonisation of pear shoots in experimental orchards using Pseudomonas spp. IPV-BO G19 and IPV-BO 3371, International Society for Horticultural Science (ISHS), Leuven, Belgium. pp. 323-328.
Bourhis, L. J., Dolomanov, O. V., Gildea, R. J., Howard, J. A. K., Puschmann, H. (2015). The anatomy of a comprehensive constrained, restrained refinement program for the modern computing environment-Olex2 dissected Acta Cryst A71: 59-75.
Broggini G. A. L., Duffy B., Holliger E., Schärer H. J., Gessler C., Patocchi A. (2005) Detection of the fire blight biocontrol agent Bacillus subtilis BD170 (Biopro®) in a Swiss apple orchard. Eur J Plant Pathol 111:93-100.
Cabrefiga J., Frances J., Montesinos E., Bonaterra A. (2011) Improvement of fitness and efficacy of a fire blight biocontrol agent via nutritional enhancement combined with osmoadaptation. Appl Environ Microbiol 77:3174-81.
Chen X. H., Scholz R., Borriss M., Junge H., Mogel G., Kunz S., Borriss R. (2009) Difficidin and bacilysin produced by plant-associated Bacillus amyloliquefaciens are efficient in controlling fire blight disease. J Biotechnol 140:38-44.
Dabboussi, F., Hamze, M., Singer, E., Geoffroy, V., Meyer, J., & Izard, D. (2002). Pseudomonas mosselii sp. nov., a novel species. Int J Syst Bacteriol, 52:363-376.
Dolomanov, O. V., Bourhis, L. J., Gildea, R. J, Howard, J. A. K. & Puschmann, H. (2009), OLEX2: a complete structure solution, refinement and analysis program. J Appl Cryst 42:339-341.
Elshahawy, I. E. and R. S. El-Mohamedy (2019). Biological control of Pythium damping-off and root-rot diseases of tomato using Trichoderma isolates employed alone or in combination. Journal of Plant Pathology 101 (3): 597-608.
Galasso O., Sponza G., Bazzi C., Vanneste J. L. (2002) Characterisation of two fluorescent strains of Pseudomonas as biocontrol agents against fire blight, International Society for Horticultural Science (ISHS), Leuven, Belgium. pp. 299-307.
García-Valdés E., Lalucat J. (2016) Pseudomonas: Molecular phylogeny and current taxonomy, in: R. S. Kahlon (Ed.), Pseudomonas: Molecular and Applied Biology, Springer.
Gavrish, E., Bollmann, A., Epstein, S., & Lewis, K. (2008). A trap for in situ cultivation of filamentous actinobacteria. J Microbiol Methods 72:257-262.
Gnanamanickam, Samuel S. (Roanoke, VA, U. (2010). Pseudomonas bacterium (U.S. Pat. No. 20,100,093538)
Gorshkov, V., E. Osipova, M. Ponomareva, S. Ponomarev, N. Gogoleva, O. Petrova, O. Gogoleva, A. Meshcherov, A. Balkin, E. Vetchinkina, K. Potapov, Y. Gogolev and V. Korzun (2020). Rye Snow Mold-Associated Microdochium nivale Strains Inhabiting a Common Area: Variability in Genetics, Morphotype, Extracellular Enzymatic Activities, and Virulence. J Fungi (Basel) 6 (4).
Gouveia, C., R. B. Santos, C. Paiva-Silva, G. Buchholz, R. Malhó and A. Figueiredo (2024). The pathogenicity of Plasmopara viticola: a review of evolutionary dynamics, infection strategies and effector molecules. BMC Plant Biology 24 (1): 327.
Groben, G., B. B. Clarke, J. Murphy, P. Koch, J. A. Crouch, S. Lee and N. Zhang (2020). Real-Time PCR Detection of Clarireedia spp., the Causal Agents of Dollar Spot in Turfgrasses. Plant Dis 104 (12): 3118-3123.
Guindon S., Gascuel O. (2003) A simple, fast, and accurate algorithm to estimate large phylogenies by maximum likelihood. Syst Biol 52:696-704.
Gwinn K. D. (2018) Chapter 7—Bioactive natural products in plant disease control, in: R. Atta ur (Ed.), Studies in Natural Products Chemistry, Elsevier. pp. 229-246.
Haas D., Défago G. (2005) Biological control of soil-borne pathogens by fluorescent pseudomonads. Nat Rev Microbiol 3:307.
Hamamoto, H., Urai, M., Ishii, K., Yasukawa, J., Paudel, A., Murai, M., Kaji, T., Kuranaga, T., Hamase, K., Katsu, T., Su, J., Adachi, T., Uchida, R., Tomoda, H., Yamada, M., Souma, M., Kurihara, H., Inoue, M., & Sekimizu, K. (2015). Lysocin e is a new antibiotic that targets menaquinone in the bacterial membrane. Nat Chem Biol 11:127-133.
Jiao, R., Y. Cai, P. He, S. Munir, X. Li, Y. Wu, J. Wang, M. Xia, P. He, G. Wang, H. Yang, S. C. Karunarathna, Y. Xie and Y. He (2021). Bacillus amyloliquefaciens YN201732 Produces Lipopeptides With Promising Biocontrol Activity Against Fungal Pathogen Erysiphe cichoracearum. Front Cell Infect Microbiol 11:598999.
Johnson K. B. S. V. O. (2000) Biological control of fire blight, in: e. J. L. Vanneste (Ed.), Fire Blight: the Disease and its Causative Agent, Erwinia amylovora, CABI Publishing, Wallingford, UK . . . pp. 319-338.
Knackmuss, H., Medizinische, M., & Chemie, I. (1968). Methyl-substituted 2,3,6-trihydroxypyridines and their oxidation products. Eur. J. Inorg. Chem. 2689:2679-2689.
Kunz S., Schmitt A., Haug P. (2011) Development of strategies for fire blight control in organic fruit growing, International Society for Horticultural Science (ISHS), Leuven, Belgium. pp. 431-436.
Laux P., Wesche, J., Zeller, W. (2003) Field experiments on biological control of fire blight by bacterial antagonists. J. Plant Disease Prot. 110:401-407.
Li W., Rokni-Zadeh H., De Vleeschouwer M., Ghequire M. G., Sinnaeve D., Xie G. L., Rozenski J., Madder A., Martins J. C., De Mot R. (2013) The antimicrobial compound xantholysin defines a new group of Pseudomonas cyclic lipopeptides. PLOS One 8: e62946.
Lindow S. E., McGourty G., Elkins R. (1996) Interactions of antibiotics with Pseudomonas fluorescens strain A506 in the control of fire blight and frost injury to pear. Phytopathology 86:841-848.
Loots, D. T., Erasmus, E., & Mienie, L. J. (2005). Identification of 19 new metabolites induced by abnormal amino acid conjugation in isovaleric acidemia. Clin Chem, 51:1510-1512.
Masschelein J., Jenner M., Challis G. L. (2017) Antibiotics from Gram-negative bacteria: a comprehensive overview and selected biosynthetic highlights. Nat Prod Rep 34:712-783.
Mikiciński A., Puławska J., Molzhigitova A., Sobiczewski P. (2020) Bacterial species recognized for the first time for its biocontrol activity against fire blight (Erwinia amylovora). Eur J Plant Pathol. 156:257-272.
Mikiciński A. S., P.; Berczyński. S. (2008) Selection of bacteria from epiphytic populations on apple trees and soil environment for ability to control fire blight (Erwinia amylovora). Phytopathol. Pol. 47:43-55.
Norelli J. L., Jones A. L., Aldwinckle H. S. (2003) Fire blight management in the twenty-first century-Using new technologies that enhance host resistance in apple. Plant Disease 87:756-765.
Osipov, A. M., Metlova, L. P., Baranova, N. V, & Rudakov, E. S. (1978). New derivatives of difuryl: 2,2′-difuryl-5,5′-dicarbinol and 2,2′-difuryl-5,5′-dicarboxylic acid. Ukrainskii Khimicheskii Zhurnal (Russian Edition), 44:398.
Pascual, J., García-López, M., Carmona, C., Sousa, T. da S., de Pedro, N., Cautain, B., Martín, J., Vicente, F., Reyes, F., Bills, G. F., & Genilloud, O. (2014). Pseudomonas soli sp. nov., a novel producer of xantholysin congeners. Syst Appl Microbiol, 37:412-416.
Paulin J. P. (1978) Biological control of fire blight: Preliminary experiments, Proceedings of the 2 International Conference Plant Pathogenic Bacteria. pp. 525.
Pérez-García, A., D. Romero, D. Fernández-Ortuño, F. López-Ruiz, A. De Vicente and J. A. Torés (2009). The powdery mildew fungus Podosphaera fusca (synonym Podosphaera xanthii), a constant threat to cucurbits. Mol Plant Pathol 10 (2): 153-160.
Peix A., Ramírez-Bahena M.-H., Velázquez E. (2018) The current status on the taxonomy of Pseudomonas revisited: An update. Infect Genet Evol. 57:106-116.
Pujol M, Badosa E, Manceau C & Montesinos E (2006) Assessment of the environmental fate of the biological control agent of fire blight, Pseudomonas fluorescens EPS62e, on apple by culture and real-time PCR methods. Appl Environ Microb 72:2421-2427.
Savory, E. A., L. L. Granke, L. M. Quesada-Ocampo, M. Varbanova, M. K. Hausbeck and B. Day (2011). The cucurbit downy mildew pathogen Pseudoperonospora cubensis. Mol Plant Pathol 12 (3): 217-226.
Sheldrick, G. M. (2008). A short history of SHELX. Acta Cryst. A64: 112-122.
Sheldrick, G. M. (2015). Crystal structure refinement with SHELXL Acta Cryst. C71: 3-8.
Stockwell V. O. D. B. (2012) Use of antibiotics in plant agriculture. Rev. Sci. Tech. Off. Int Epiz. 31:199-210.
Strickland, D. A., J. P. Spychalla, J. E. van Zoeren, M. R. Basedow, D. J. Donahue and K. D. Cox (2023). Assessment of Fungicide Resistance via Molecular Assay in Populations of Podosphaera leucotricha, Causal Agent of Apple Powdery Mildew, in New York. Plant Dis 107 (9): 2606-2612.
Thomson S. V. S. M. N., Moller W. J., Reil W. O. (1976) Efficacy of bactericides and saprophytic bacteria in reducing colonization and infection of pear flowers by Erwinia amylovora. Phytopathology 66:1457-1459.
Tianna D. K., Johnson; Rachel, Elkins; Tim, Smith; David, Granatstein. (2018) Organic Fire Blight Management in the Western U.S.-extension, Organic agriculture.
Vrancken K., Holtappels M., Schoofs H., Deckers T., Valcke R. (2013) Pathogenicity and infection strategies of the fire blight pathogen Erwinia amylovora in Rosaceae: state of the art. Microbiology 159:823-32.
Wilson M., Epton H. A. S., Sigee D. C. (1992) Biological-control of fire blight of Hawthorn (Crataegus-Monogyna) with fluorescent Pseudomonas spp under protected conditions. Journal of Phytopathology-Phytopathologische Zeitschrift 136:16-26.

### INCORPORATION BY REFERENCE

All literature, publications, patents, patent applications, and related material cited here are incorporated by reference as if fully set forth herein.

What is claimed is:

1. A method of controlling a disease in a crop caused by a pathogenic microorganism comprising the steps of
producing an agricultural composition comprising a Pseudomonas bacterial metabolite as Formula (I) 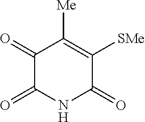 [SMILES: CSC1=C(C)C(=O)C(=O)NC1=O]
and
applying the agricultural composition to the crop to inhibit the growth of the pathogenic microorganism.

2. The method of claim 1, wherein the disease in the crop caused by the pathogenic microorganism selected from the group consisting of damping-off, root rot, powdery mildew, downy mildew, dollar spot, and pink snow mold.

3. The method of claim 1, wherein the pathogenic microorganism is selected from the group consisting of Pythium aphanidermatum, Podosphaera xanthii, Plasmopara viticola, Erysiphe cichoracearum, Pseudoperonospora cubensis, Clarireedia jacksonii, Microdochium nivale, and Podosphaera leucotricha.

4. The method of claim 1, wherein the crop is selected from the group consisting of cucurbits, legumes, leafy greens, root vegetables, oilseed crops, ornamental plants, fruit crops, and turfgrass.

5. The method of claim 1, further comprising controlling an infection in the crop by the pathogenic microorganism after a specified duration of applying the agricultural composition at an effective concentration to the crop.

6. The method of claim 5, wherein the effective concentration of the agricultural composition is from about 20 μg/mL to about 300 μg/mL of Formula (I).

7. The method of claim 1, wherein the bacterial strain used for producing the agricultural composition is selected from the group consisting of Pseudomonas soli 0617-T307 having Accession No. PTA-126796, Pseudomonas soli 0917-T305 having Accession No. PTA-126797, Pseudomonas soli 0917-T306 having Accession No. PTA-126798, Pseudomonas soli 0917-T307 having Accession No. PTA-126799, Pseudomonas mosselii 0118-T319 having Accession No. PTA-126800, Pseudomonas mosselii 0318-T327 having Accession No. PTA-126801, and Pseudomonas mosselii 0418-T328 having Accession No. PTA-126802.

8. The method of claim 1, wherein the agricultural composition selected from the group consisting of a solution, a suspension concentrate, a wettable powder, a water-dispersible granule, or a soluble liquid.

9. The method of claim 1, wherein the agricultural composition further comprises an adjuvant, a surfactant, or a solvent to enhance the efficacy of Formula (I).

10. The method of claim 1, wherein applying the agricultural composition to the crop is performed by treating the crop with the agricultural composition selected from the group consisting of a foliar spray, a soil drench, or a seed coating.

11. The method of claim 1, wherein the agricultural composition protects the crop against disease caused by the pathogenic microorganism for at least seven days post-application of the agricultural composition.

12. A method of controlling a disease in a crop caused by a pathogenic microorganism, comprising applying an agricultural composition comprising between 1.0×10⁵ and 1.0×10⁹ cfu per mL of a Pseudomonas bacterial strain to the crop to inhibit the growth of the pathogenic microorganism.

13. The method of claim 12, wherein the Pseudomonas bacterial strain is selected from the group consisting of Pseudomonas soli 0617-T307 having Accession No. PTA-126796, Pseudomonas soli 0917-T305 having Accession No. PTA-126797, Pseudomonas soli 0917-T306 having Accession No. PTA-126798, Pseudomonas soli 0917-T307 having Accession No. PTA-126799, Pseudomonas mosselii 0118-T319 having Accession No. PTA-126800, Pseudomonas mosselii 0318-T327 having Accession No. PTA-126801, and Pseudomonas mosselii 0418-T328 having Accession No. PTA-126802.
